(19) United States
(12) Patent Application Publication
(10) Pub. No.: US 2002/0119433 A1
(43) Pub. Date: Aug. 29, 2002

(54) Process and system for creating and administering interview or test

(76) Inventor: Thomas J. Callender, Lafayette, LA (US)

Correspondence Address: C. Dean Domingue, Domingue & Waddell, PLC, Box 75, Suite 515, 600 Jefferson Street, Lafayette, LA, 70501, US

(21) Appl. No.: 09/739,051

(22) Filed: Dec. 15, 2000

(51) Int. Cl. G09B 7/00

(52) U.S. Cl. 434/322

(57) ABSTRACT

A process and system for creating and administering flexible, complex, error free electronic interviews or test of any kind. The process includes creating a library containing a plurality of self contained objects, i.e. question functional statements (QFUs). The QFUs are modules comprising a question statement, controls for answering the question statement, internal scoring controls, and controls for generating an unlimited variety of reactions or software responses to each answer. A plurality of categories is created to index QFUs wherein the category names are based on a tree structure relationship. These QFUs are used to build simple groups of QFU that are commonly found together, i.e. macro questions, as well as questionnaire templates. Questionnaire templates consists of multiple QFUs and categorical headings that are arranged in a two dimensional tree structure in a manner to logically represent the logical inter relationships between the different QFUs. A plurality of question macros in a macro library and a plurality of questionnaire templates are devices that allow rapid development of new questionnaires. The process further comprises placing these devices on a server for access via network being limited to authorized administrative users. The process also comprises creating an interview as an instance of the questionnaire template that can be distributed to clients on a network and applied to a specific interviewee. The server can be accessed by a plurality of authorized users from remote computers via a network.

### BACKGROUND OF THE INVENTION

The system and method herein described is used to create and deploy intelligent, electronic questionnaires used to querying an interviewee with a series of predefined questions and answer formats and that processes, manages and displays the collected information.

Many fields of human endeavor now use, or could greatly benefit from, questionnaires to collect information in a structured fashion. The use of questionnaires is common place in many fields in order to systematically ascertain information for numerous purposes. These fields include, but are not limited to, business, law, engineering, science, medicine, epidemiology, testing, psychological interviews, marketing surveys, military as well as any mission critical endeavor.

Prior art information input methods (i.e. prior art questionnaires) need to be greatly improved by creating a general purpose, automated method that is intuitive yet allows one to quickly create and deploy an infinitely complex and flexible end product. There is a need for a system that would allow maximum flexibility and ease for allowing modifications to an existing questionnaire. There is also a need for a system that will allow for the information collection process to be filtered, conditioned or managed according to a previously defined set of rules that are easy to create and apply but complex enough to allow for any input scenario application. Furthermore, there is a need for a system to take the collected information and to use it to trigger complex software behaviors and must be easily integrated into other software applications that may need the collected information or the consequence of that information. While prior art versions of software controlled or adaptive questionnaires, i.e. tests, are now available, they have significant limitations and do not fill most of these requirements.

These objectives are met via the novel system and method herein disclosed. The systems and methods are based on a thorough analysis of the fundamental logic and information flow required to build and store and present questions as well as how that information is to be used. In addition, the novel methodology takes into consideration how software tools and techniques can be used to rapidly and efficiently create, edit and implement a comprehensive, customized electronic questionnaire system that can be rapidly adapted for any purpose and then distributed over a network.

### SUMMARY OF THE INVENTION

In one of the embodiments, the system and method allows an administrative user to quickly generate password protected, sophisticated electronic questionnaire templates with complex rules and programmable behaviors for each question in that template. Once a questionnaire template is created, the questionnaire template serves as a modular tool to build other questionnaire templates of increasing complexity as well as a tool that can be distributed on a network to allow deployment of production interviews, i.e. functional questionnaires for specific clients or groups of clients, by generating instances of that questionnaire template. The interviews can be created, modified or administered via intranet, Internet, stand alone work stations or hand held devices. The interviewee then interacts with, and completes, the interview by answering the queries or questions contained in the interview.

As each question is engaged, the pre programmed control means for that question are activated. For example, when one specific answer in a multiple choice question is answered, then a set of control means contained in the QFU are activated and the answer is evaluated. Then other predefined control means in the QFU are activated by the specific answer such as to send E-mail or to load a browser with a link to a universal resource locator (URL) or to activate any other program. Each question has an icon that is displayed with each QFU and during an interview gives a visible, symbolic representation of the status of that question. That icon gives a continuous, real time, visible representation of each question's status and which changes during the interview according to the changes in questions status for each question as well as categories or headings for groups of questions. For example, when the status of a question changes from one of the following possible states, e.g. Not read yet, Completed, Refuse to answer, Deferred to later, . . . then the status icon displayed with each question changes appropriately. Once all the questions downstream from a category are completed, then the category icon changes also.

This questionnaire system contains a series of questions and can adapt or modify itself depending on the interviewee responses or data external to the interview. Each question is implemented as a self contained object, i.e. question functional unit that consists of a series of programmable components that includes the statement of the question as well as means for answering the question and all rules or programming to be associated with that question.

In the preferred embodiment, the process for interviewing comprises creating a first plurality of question functional units (QFUs), with the QFUs comprising a question statement, a means for answering the question statement and the rules used to process and react to the answers. The process further includes creating a first plurality of categories that are assigned to each QFU. Next, the process then includes creating a questionnaire template by placing the QFUs into a multidimensional tree structure that expresses their logical relationships to each other. The completed questionnaire template can then be placed on a network server for distribution or used to create applications, e.g. interviews.

The process further comprises restricting access to the library of QFUs and questionnaire templates to a plurality of authorized users. Depending on their subscription and authorization, users can access the server from a remotely located computer to build or deploy questionnaire templates and create interviews.

Each QFU contains a mechanism for answering a question which must be initialized by a complex set of facts to create the rules needed to collect and process the answer data. Providing these facts when building large numbers of QFU would be very time consuming, therefore this method provides a means for using default data to initialize the data needed to create a functional set of answer rules. This answer mechanism provides for a means to define the general method of answering a question, a means for providing an answer based on a predetermined list of choices, and a means for allowing flexible units of measure choices by the interviewee and then for converting those units of measure of the answer from any first unit of measure to any other unit of measure as needed.

Some interviews require certain subsections to be applied multiple times depending on the facts relevant for a specific interviewee. Enabling this capability involves several steps:

The first step includes selecting and defining a questionnaire template as a secondary questionnaire and assigning that secondary questionnaire to a background template object. A marker representing this background template object is then embedded at a specific position inside the primary questionnaire template where the multiple secondary questionnaire templates are to be inserted “N” times where “N” is the number of times defined by a specific interviewee's input.

The process would be completed when the background template marker is encountered during an interview by the interviewee. This would then result in the insertion of multiple secondary questionnaire templates the appropriate number of times.

The process of building QFU may further include modules capable of generating statistical analysis of the answers or linking to statistical software packages.

In one of the embodiments, the questionnaire template server is linked to a global computer information network that can be accessed from any authorized remote computer client. This allows remote users to access, remove, create, edit and deploy a library of software tools, QFU and questionnaire templates for which that user has authorization. This library is a subset of the master library of QFU, tools and questionnaire templates.

The process may further involve sending specific e-mail messages based upon the answer provided by the interviewee. This is done by comparing that interviewee's answer to a predetermined answer profile stored in the QFU. Additionally, depending on the interviewee's specific answer to a question, each specific answer response to a question can be linked to a different universal resource locator on a network, e.g. world wide web, via a web browser program or other software packages.

This questionnaire building process further involves saving any new or modified QFU(s) in a library as a file on the questionnaire template server, and wherein the file may be accessed at later time to be edited or used as a tool to build new questionnaire templates or to deploy as interviews.

This questionnaire process allows performing real time scoring and/or statistical analysis on each specific answer to a question or performing batch statistical analysis on any group of QFUs in any group of interviewees. This is accomplished by embedding a set of rules inside of each QFU to condition or filter answer data as well as to indicate what statistics are to be used and under what circumstances and for each possible answer. Furthermore, any selection of interviewees can be assigned to a group.

Each QFU contains information that indicates which general class of answers (i.e. answer format classifications) are appropriate for that question statement as well as specific information needed to answer that question statement. For example, the general class of answer for a certain question statement could include choosing a multiple choice format and then the specific information would include a specific set of answer choices making up the possible multiple choices for that specific question statement.

A data management question and answer system is also disclosed. The system includes a master library consisting of a plurality of question functional units (QFUs) as well as the components and tools needed to build QFUs, e.g. question statements, answer format classifications, specific answer data, rules for filtering, conditioning and analyzing data and rules for reactions to data as well as the means necessary for answering the question statements. The system also includes the means for editing and customizing all QFU and all QFU components that make up each QFU. For example, this includes a means for creating dynamic and customized answer format classifications for maximum flexibility and speed in creation of error free question functional unit (QFU) or QFU components.

The system further comprises a means for real time adaptation of a live interview whereby the interview can insert another entire questionnaire template multiple times into the live interview as needed. This allows a practical means for customizing a questionnaire to the needs of each interviewee in real time. To enable this capacity, a special background template marker is embedded into a node in the tree structure of the questionnaire. When this background template marker is encountered inside a live interview, the background template gathers all of the necessary information and then inserts the secondary questionnaire the correct number of times at that node inside the primary interview with each instance of the secondary questionnaire template being correctly labeled with the newly acquired data. The primary interview is then generated as an instance of the primary questionnaire template that has now been modified with multiple secondary questionnaire templates.

Once the background template is created and named, the system provides for linking the secondary questionnaire template with the background template marker name and then indicating at what node, i.e. position in the primary questionnaire template, the background template marker is to be positioned. The system creates a means for inserting the secondary questionnaire template into the primary questionnaire template once the background template marker is encountered during a live interview.

The system may also contain means for generating a statistical analysis of the answers in real time and in a batch mode.

In a third embodiment, an object oriented programming based process and system for optimizing a method for rapidly creating and administering flexible, complex, error free electronic interviews or test of any kind is disclosed. The process includes creating a library containing a plurality of self contained objects, i.e. question functional statements (QFUs). The QFUs are modules comprising a question statement, means for answering the question statement, internal scoring rules, rules for generating an unlimited variety of reactions or software responses to each answer. A plurality of categories are created to index QFUs, these category names are then applied to create a tree structure relationship. These QFUs are used to build simple groups of QFU that are commonly found together, i.e. macro questions, as well as questionnaire templates. Questionnaire templates consists of multiple QFUs in categorical headings that are arranged in a two dimensional tree structure in a manner to logically represent the logical inter relationships between the different QFUs. A plurality of question macros in a macro library and a plurality of questionnaire templates are tools that allow rapid development of new questionnaires by capitalizing on the work that has gone into building previous individual questions and complex groups of questions. The process further comprises placing all of these tools on a server for access via network and is limited to authorized administrative users. The process also comprises creating an interview as an instance of the questionnaire template which can then be distributed to clients on a network and applied to a specific interviewee. The server can be accessed by a plurality of authorized users from remote computers via a network.

The means for answering questions includes classifying all possible answer methods into a small set of answer formats hereinafter defined as question prototypes. Each question prototype includes a statement of the general method of answering a question statement plus the status of each question, the status of each answer, means for initializing data needed to score answers in real time during the interview, a means for providing a default data initialization, a means for creating and storing possible answer sets as a predetermined list of answer choices, a means allowing interviewee to enter any unit of measurement for a numerical answer and then for converting the units of measure of the answer from any one unit of measure to any other unit of measure as needed (e.g. miles to kilometers to feet).

The creating of the QFUs comprises inputting the question statement, defining the answer format by selecting the question prototype, defining the possible answers as well as the significance and scoring methods for each possible answer, and software response to each answer. Groups of simple lists of QFU that are frequently found together are put into macro questions. The creation of a questionnaire comprises creating and/or selecting individual QFUs and then using drop and drag techniques to build a questionnaire template as a two dimensional tree structure that is then used to generate actual interviews. This system contains the maximum adaptive capability for any electronic test or questionnaire. This includes (I) scoring each question in real time by storing scoring information inside each QFU and comparing the interviewees answer to the reference data as soon as the data is entered; (ii) allowing answers to questions to disable subsets of the questionnaire template that are not logically compatible with current facts and/or enable subsets of the questionnaire that are logically compatible with current facts—those facts could be interviewee's answers or external data streams; (iii) allowing a live interview to query interviewee with predefined questions and then make major changes in the primary interview on the fly by inserting entirely new secondary questionnaire templates based on this query. This is done by embedding a background template marker into a node in the tree structure of the primary questionnaire template that triggers this query and multiple insertion of secondary questionnaire templates when that marker is encountered during an interview.

A feature of the novel system includes the interviewee interacts with the interview, rules associated with each specific QFU question in that interview are engaged. As these rules of engagement are activated, they effect how a question is presented, how data is collected and evaluated, modify the interview on-the-fly based on incoming answers and control reactions to the data by launching predefined subroutines based on the interviewee's answers.

Another feature is that the system and method creates a library of tools that are used to generate and save a dynamic, reusable questionnaire template which is used to create specific instantiations for specific applications.

Another feature includes creating questionnaire template tools consisting of question functional unit (QFU) sub components that are used to create single questions, groups of questions and entire questionnaires. Another feature includes inserting these tools into the appropriate QFU, macro or questionnaire template.

To make use of previously created QFU, a specific QFU must be located in a large QFU library. The system allows various methods of sorting and ordering this library of QFUs by answer type and alphabetically as well as providing techniques for searching for specific text in QFU libraries and by question prototype.

Yet another feature includes dynamically controlling the pathway an interviewee can traverse through the two dimensional tree structure of the interview based on the answers provided by the interviewee or as driven by external data. Some pathways are disabled and others are enabled based on these factors and some answer options are displayed or hidden as is appropriate thus pruning the questionnaire template tree to fit the situation at hand thus making a dynamic, adaptive questionnaire with unlimited flexibility. Linking all of these components together creates the final questionnaire template which is then saved for future use.

Another feature is that the final questionnaire template can then be deployed as an actual interview by creating an instance of the questionnaire template with the addition of specific information for a specific user or interviewee.

This interview can then be distributed via networks, optical or magnetic discs to be run by an interviewer for a specific interviewee. In the preferred embodiment, however, the interview is run on a server with the interviewee being a server client.

Another feature includes the ability for an administrative user to access the questionnaire server and then create a questionnaire template. If desirable, the administrative user could select and open a previously created questionnaire template and then edit the questionnaire template tools or use these tools to create and save a new questionnaire template.

Another feature is that the administrative user can then use the questionnaire template to produce a functional interview for a specific interviewee or a group of interviewees who have interview rights. The interviewee will actually use the end product and provide the answers to the questions in the interview.

Still yet another feature is that the questionnaire server may be linked to a global computer information network, such as the Internet or an Intranet.

For an administrative user, accessing the server would also allow access to the library of tools, with the administrative user having the ability to create or edit QFUs, QFU components, question macros, background templates or questionnaire templates as well as to deploy questionnaire templates for specific interviewees or to perform any other functions from a remote site.

Yet another feature is that the applied interview can then be accessed and administered on the server from a remote computer linked to the server via that network. Another feature is the ability to have the server on a stand alone work station and generate interviews that can be published via CD, DVD or magnetic discs.

The system allows QFUs to be put in an expanding/collapsing tree structure that is easily manipulated and modified by common insert, delete, drag and drop software tools. The system allows any number of logically associated QFUs to be assigned to macro questions. Those macro questions or groups of questions can then be quickly inserted into future questionnaires whereby the macro is expanded into all of the original, individual QFUs. This eliminates time consuming data entry and error when building new questionnaires templates.

Another system feature includes allowing a group of questions (i.e. macro questions) to be inserted into template questionnaires. Template questionnaires can also be inserted into other questionnaire templates further increasing the speed by which new questionnaires can be created from tools created from other questionnaire templates and QFUs.

Still yet another feature is that all questionnaires can be described as having a two dimensional tree structure with multiple nodes, branches and pathways. The system allows the creator of a questionnaire template to create an intuitive, logical, visual representation of a questionnaire that allows specific pathways to be dynamically enabled or disabled during a live interview as a reaction to the interviewee's answers to specific questions or to an external data stream. Each specific pathway contains multiple questions and/or headings.

Another feature is that the system allows the creator of a QFU to use predefined or customized answer formats (i.e. question prototypes) that allows for complex methods to prompt the interviewee during an interview to gather answer information. These QFUs can be built and stored as reusable objects to allow for quick and accurate creation of complex questions. These answer formats have the ability to exhibit useful and complex behaviors by dynamically reacting and modifying themselves in response to interviewee input.

Another feature is that the system allows subjects to be assigned to predefined groups and then allows statistical analysis software to be applied to the answers for this group. This feature allows the method to be used in epidemiological studies, opinion polls, registries, surveys and other similar applications involving groups of subjects.

Another feature is that the system keeps tract of and displays the status of each question in real time. The system keeps track of what questions were asked and answered and posts visible icons in the tree representation of the active interview to indicate the status of each question and each tree structure branch. If a interview is interrupted while in progress, the system allows the user to start up automatically at the same question at a later time and to see indicators of the status of each part of the interview. If an interviewee jumps for one question to another at random, he/she can always see which questions still need to be answered.

Still yet another feature is that the system also allows users to build their own questionnaire template over a network, e.g. internet, or to import previously created questionnaire templates that they can use or modify.

Another feature is that the system allows any answer to any question to have a predefined response or action that is launched when that answer is input by the user. Those responses can include engaging other applications, opening a browser to a URL address or engaging any other programmed responses. These responses can be directly determined by data input to that answer form or by reference to any other data, e.g. data from other areas in that interview, databases, OLE, etc.

Yet another feature is that the applied questionnaire templates, i.e. interviews, can run independently from the server as a platform independent application on a client work station. Still yet another feature is that each question can have links to text, video, audio, URLs, software programs, voice, direct communications links with supervisors.

### BRIEF DESCRIPTION OF THE DRAWINGS

FIG. 1A is a schematic flow chart of an embodiment of the present invention.

FIG. 1B is an exemplary questionnaire template with tree structure including details of the QFUs.

FIG. 2A is a schematic flow chart of a tree structure of one embodiment of the present invention.

FIG. 2B is an exemplary questionnaire template library with selected questionnaire templates and tree structure.

FIG. 2C is a schematic flow chart of one embodiment of the data base interactive management system.

FIG. 2D is a chart showing details of a QFU.

FIG. 3A is a schematic flow chart of the order of a group of questionnaire templates in database/library.

FIG. 3B is a schematic flow chart of the path of a single questionnaire template.

FIG. 4 is a schematic flow chart of an interview with the system allowing for statistical analysis.

FIG. 5 is a schematic flow chart of an embodiment linked with a global network of computers.

FIG. 6 is a schematic flow chart of an embodiment of a closed, secure network of computers.

FIG. 7A is a schematic representation of a file containing a plurality of macro questions.

FIG. 7B is a schematic representation of a the QFUs contained within a macro question.

FIG. 8 is a schematic representation of a file containing selected macro questions for an interview.

FIG. 9 is a block diagram of the major components of the most preferred embodiment of the system.

FIG. 10 is a schematic representation of a screen depicting the management of background templates and selection of secondary questionnaires.

FIG. 11 is a schematic representation of a screen depicting the linking a primary questionnaire template to a specific background template marker name.

FIG. 12 is a schematic representation of a screen depicting the node position inside the primary questionnaire where the background template marker is to be located.

FIG. 13 is a schematic representation of a screen depicting the secondary questionnaire template that is to be inserted at the background template marker inside the primary questionnaire template.

FIG. 14 is a schematic representation of a screen that allows the user to edit data on a particular background template.

FIG. 15 is a schematic representation of a screen that depicts which existing primary questionnaire templates are linked to which background templates at which nodes in the primary questionnaire.

FIG. 16 is a flow chart representation of the utility function of the maintenance portion of the system.

FIG. 17 is a schematic representation of a screen that depicts a question category tree.

FIG. 18 is a flow chart representation of the apply function of the questionnaire system to create an interview and generate reports.

### DETAILED DESCRIPTION OF THE PREFERRED EMBODIMENTS

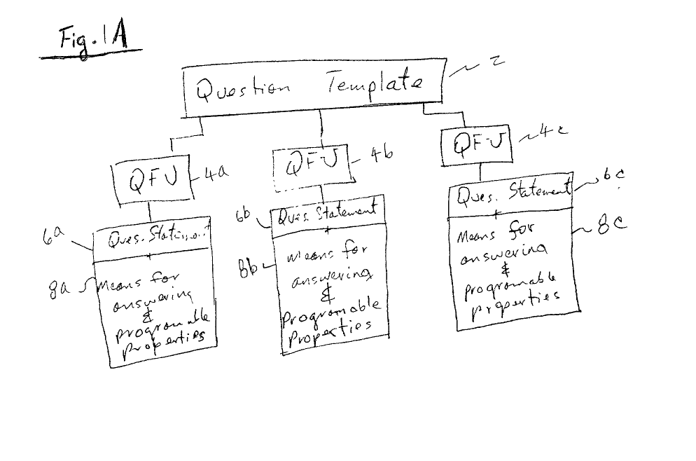

An embodiment of the present invention is disclosed in FIGS. 1 through 8. Referring to FIG. 1A, an overview of one of the embodiments of the present invention is presented in a flow chart illustration. A question template 2 includes a plurality of question functional units (QFUs) 4a, 4b, 4c. Each QFUs 4 includes a question statement 6a, 6b, 6c and means for answering coupled with programmable properties 8a, 8b, 8c.

The question functional unit (QFU) 4 is a question statement plus a means of answering the question as well as a means for collecting and scoring the answer, means for modifying the questionnaire during the interview and means for reacting to the answer in a complex, preprogrammed fashion as it is provided. It should be noted that the QFU can be considered an object. A question statement 6 means a logical, complete thought stating the question but with no means of answering that question.

A questionnaire template 2 is an object that is a precursor for creating an interview and that contains a series of QFUs arranged in a logical, intuitive, two dimensional array as an expandable, tree-and-branch structure with appropriate category labels and status icons at the nodes of the branches. As used herein, an interview is an applied questionnaire template, i.e. an instance or production copy of a questionnaire template that has been labeled with data relevant for a specific user.

A question macro refers to a list of QFUs that is one dimensional (i.e. a simple list) that are stored together because they are frequently used as a group. All QFU components placed in the question macro will be found at the same node level in the questionnaire template or interview.

A secondary questionnaire template is a two dimensional array of QFUs that forms a complete questionnaire and that is inserted into primary questionnaire templates 2 for rapid development. A questionnaire template can therefore be primary and/or secondary depending on how it is used.

One important component of the QFU 4 is that it contains programmable properties, complex set of control means (rules of engagement) that are reactions to be triggered by the interviewee's answers and/or external data. This component allows for customizable or third party software to be installed by the administrative user and linked to each component of any answer. When that component of the answer is chosen, e.g. one possible answer in a multiple choice question, then the appropriate software module will be activated and can execute any task as determined by that software. For example, a hospital may use the questionnaire system to screen incoming patients. If they decide that their policy is to immediately notify the psychiatrist on call if a patient admits to having a drug problem then the questionnaire administrator can link an e-mail to the affirmative for that question's answer. Then, whenever that question is answered in the affirmative during an interview given by ancillary personnel, then an appropriate message would be sent to the psychiatrist on call for that day. Thus the system would alert the responsible party to the fact that a specific type of patient is now interacting with the hospital staff at a specific location and time.

Another example from the field of medicine would involve questionnaires to request information from patients. Such questions would include the patients symptoms, medical history, information regarding use of medications, allergies, etc. The information gathered from these questionnaires is essential for diagnosis and treatment of illness and becomes the cornerstone of the entire medical diagnosis and treatment process. Providing a question management system that is user friendly for the questionnaire designer as well as the test subject or end user is important, especially due to the fact that the questionnaire could be modified frequently and need to be in production immediately. Furthermore, it is necessary to provide a method that allows user friendly, simple, intuitive implementation of functions normally only seen with sophisticated programming techniques. It is also important to not only get accurate answers and to store them in a database but to also allow for various methods of complex analysis of that data. This questionnaire system allows the administrative user to create and store procedures with each question. Those procedures allow for relevant decision making capacity and data analysis algorithms for each question to be stored with that question, and many forms of analysis, e.g. test scoring, can be completed in real time.

FIG. 1B is an exemplary questionnaire template with tree structure and details of the QFUs 4a, 4b, 4c. The QFU 4a would include the question statement 6a “did you ever have to attend special education?”, and question prototype 8a, and status of question. The QFU 4b would include the question statement 6b “where was this program?”, question prototype 8b, and status of question. The QFU 4c would include the question statement 6c “type disability (hearing, sight, dyslexia . . . )?” and question prototype 8c and status of question.

Other procedures stored in the QFU 4 can also make complex decisions and set flags in real time that can indicate question status as well as to define an unlimited variety of other meaningful database fields. For example, if a patient answers a question in a particular manner and that choice was defined to be abnormal based on the rules defined for that QFU by the questionnaire author, then that question is flagged as abnormal during the interview and in real time. This flag can be used to trigger responses or in scoring the interviewee's results. Furthermore, other relevant flags can be set at that time indicating facts such as: question has (a) not been read or (b) has been read and (completed, deferred to later, refused to answer or found to be confusing). Furthermore, flags such as answer has been rated as trivial, neutral or emergency, etc can be set with a click of a mouse button.

In addition, the QFU 4 allows for capturing the answer by the patient and also allows for moderators, nurses, doctors or other persons supervising the information gathering process, to set user flags relevant for their role. For example, flags can be used by the questionnaire supervisor to instantly record their comments by checking off predefined comments saving them from having to type long or repetitious comments. For example, these stock comments could define the supervising person's opinion on the validity of the answer to that question. Furthermore, the system allows the supervising person to input free form, narrative comments for each question if they deem necessary. These comments and flags are searchable and can be used when reviewing the subject's data to filter data output during reports or searches. The system has built in statistic means that are continuously performed on these flags to update question status icons and to provide a live status board for that interview. Those basic statistics reveal data such as number and percent of questions “not read”, “read but not answered”, “answered definitively”, or answered as “I do not know”, “refuse to answer” or answered definitively but the supervising person found data to be suspect, etc. Each question is associated with an icon that is displayed to reveal its status when the two dimensional question array is displayed. Furthermore, the entire interview is scanned periodically to determine and display the status of each question and to update the status board that shows the stats regarding how complete the questionnaire is at that time.

The QFUs 4a, 4b, 4c are easily integrated into a questionnaire due to two techniques, i.e. drag and drop and tree control display. The tree control display allows all of the questions in their relative positions as a branching tree with questions at each node, as will be more fully set out later. The tree display allows for categories of questions to be indented underneath relevant heading therefore revealing the logical relationships between all questions.

Using this method, virtually any existing complex questionnaire, i.e. a structured series of questions, can be quickly duplicated and edited without any knowledge of computer languages. The system and method uses a straightforward, intuitive, visual natural language input and simple tree structure with drag and drop maneuvers to allow questions to be created, edited and then easily inserted into any position in any questionnaires. The program in the preferred embodiment is written in Visual Fox Pro, C++ and Visual Basic to essentially create a virtual high level language questionnaire wizard or questionnaire builder. The program is written in a manner to allow the user to operate the program to create and deploy complex electronic questionnaires, tests or expert systems with an intuitive, natural language user interface and with no programming skills required. The concepts used in this method are universal and the underlying program could be written in almost any language.

For example, if a user decides to modify a questionnaire by moving an entire section or a single question into a different position in the questionnaire, then the user simply highlights that QFU in the existing questionnaire and drags it to the new location and then drops it into place.

The drag-and-drop technique (of which commercial software are readily available) allows the interviewer to grab a QFU 4 from a library or other questionnaires and then drop it into place in the new or modified questionnaire. That question is then automatically and fully integrated into the new questionnaire including statistical functions, status displays, adaptations to downstream questions as well as software packages that are triggered by the users answers. Systematic, structured data can be accumulated for individuals as well as groups with large numbers of subjects so that statistical analysis can be performed.

This questionnaire system allows each implementation to be included in predefined groups to allow statistics to be generated on each group and to restrict access to all or some of the data to authorized personnel. For example, clinical researchers could access data but be denied names or identifying information that is protected under medical record confidentiality. Each QFU 4 or subsets of the master library can be limited to specific users or groups of users. Therefore, each question in the entire interview can have independent access control.

This new method consists of creating from a modular library of questionnaire templates, question macros and individual QFU 4 that can be utilized and manipulated with drag-and-drop software techniques. In the method herein described, the QFU 4 consist of a complex object that contain a statement of the question and possible answers and multiple, programmable object properties that allow each question to launch programs or subroutines depending on the users answers.

As noted earlier, QFU 4 contains the complex of question statements 6, answer means and programmable properties 8. The QFUs 4 are quickly built and edited from a library of tools that allow maximum speed and flexibility in creating complex question objects with complex properties. The answer means and programmable properties 8 assigned to each QFU 4 can contain properties including, but not limited to, the following:

1.) definition of the method of answering the question statement, i.e. Question Prototypes (QPT); (These question prototypes include multiple choice, numerical answers, yes/no, true or false, narrative, etc);

2.) limits or constraints on possible answers; statistical properties to interface with statistical packages;

3.) set flags to determine status and allow counting of answer status;

4.) subroutines to be activated depending on user's answers and/or external data;

5.) Time allowed for a question to be answered;

6.) Whether access to this QFU 4 is restricted and, if so, then by what rules.

The QFU also allows definition of alternative languages that can be displayed instead of English and allows for a help function for each question in case an interviewee or interviewer does not understand a question. The help function in the QFU can be linked to text, audio or audiovisual aids to explain a question in any number of languages.

The question prototype is a tool that represent the possible methods for answering a question statement. QPTs include, but are not limited to, category listing only, narrative text, single number, number range, date range, approximate date, number ratio, yes/no or true/false, multiple choice, graphic input, Frequency/Duration/Intensity.

The question prototype answer form object (QPT) defines what information that is needed for each answer type, as defined above, as well as how that information is to be presented to the interviewee and what happens when an answer is provided. This includes control of all information regarding that answer type such as how much time to allow an interviewee to respond to a question, general look of data input form, security restrictions, embedded methods for reacting to each answer, etc.

As seen in FIG. 1B, the QFUs are linked together as a multiple dimensional array tree structure. The design allows the relative position of each QFU to be quickly and easily changed by the administrative user by using tree controls and drag-and-drop tools.

The questionnaire template or interview are composed of a two dimensional tree that has many branches, pathways and nodes. This branch-node system (i.e tree structure) gives a simple, intuitive visual overview and display of organizational structure and logic for the questions in the questionnaire. The system uses this tree structure to direct the user to a specific path depending on the answers from previous questions or from data external to the questionnaire. In other words, the system engages in automatic pruning of the tree or growing new branches depending on previous answers or in reaction to external data. This causes the questionnaire to only display relevant and appropriate questions to a user. This prevents the user from having to review lengthy, irrelevant text cluttered with unused or inappropriate questions and having to make decisions on the relevance of the questions. It also prevents the administrative user from having to create multiple versions of a questionnaire to fit different subjects or conditions. Question and pathways can be controlled by external factors such as data reflecting temperature, seasons, stock prices, etc. and can be modified in real time thus allowing a few general questionnaires to take the place of a large number of questionnaires with limited flexibility. As another example, questions related to sex, age, race, etc will appear or disappear as is appropriate and eliminate or bring forth other questions or blocks of questions relevant to the value of a particular answer. Each node has a symbol that represents the status of that branch. That is a different symbol is displayed for at each node that designates the status of that branch of the questionnaire/interview. For example, different symbols are used for branches not yet traversed, whether the user refused to answer, did not know the answer, made a particular answer, etc.

Another QFU property that is available is to enable or disable each question in the library if it is not to be used in the future. However, the disabled QFU are retained for reference in case they were previously used.

The data flags inside each QFU automatically evaluates during the interview to determine or update its status as well as to be read and processed.

When an interviewee suspends the process of answering an interview, the system remembers where the interviewee user stopped. Later when the interviewee restarts the interview process, then the system notifies the interviewee where he left off and posts the status of each branch and node of the interview.

This system allows different modes for administering the questionnaire. The first mode allows the interviewee to progress through the question tree at his own pace. The second method involves an automatic query function whereby the questions are automatically asked sequentially and each question is presented for a period of time defined when the question was created and stored as a property of that QFU. The third mode is where the questions are asked at random and with each question being displayed for the correct, predetermined period of time.

This questionnaire system can be managed and deployed via a network, e.g. intranet or Internet. The administrative user can choose a previously completed questionnaire or build a new questionnaire from a library of individual components or copy subsets of existing template questionnaires. A question macro is a simple, one dimensional list of predefined QFUs that have a high probability of being used together and that exist on the same level or category of a questionnaire template. A specific question macro can be inserted into a questionnaire template by inserting the question macro name at the appropriate place. The questionnaire system then substitutes all of the relevant QFUs that make up that question macro along with the properties and embedded rules for each QFU.

The questionnaire system also allows an administrative user to quickly build large and highly complex, error free questionnaires by using previously defined and tested questionnaire templates as building blocks. For example, large and complex existing questionnaires (secondary questionnaire templates) can be inserted into any other questionnaire template (primary) and then each new QFU in the primary questionnaire template can be deleted or moved. Furthermore, single questions (QFU) or groups of questions can then be deleted, added or moved as necessary using drag and drop methods. The difference between question macros and secondary questionnaire templates is that the macro is simply a list of QFUs at the same nodal level (one dimensional) and a secondary questionnaire template is a complete questionnaire template chosen from the questionnaire template library for the purpose of being inserted into another questionnaire template.

For example, during an employment interview, a specific set of questions needs to be asked for each job that a job applicant has had in the past. The types of job questions depend on information such as the type of job, when the employment took place and how many jobs the subject had. When prior art questionnaires are designed, such a section would be applied multiple times by manually asking the questions or giving the applicant multiple copies of each that section or by using software that forces the questions to be represented by a one dimensional model. This method allows a group of questions to be designed so that when an interview is being given, insertion of that section of questions will automatically recycle for the appropriate number of times required for that interviewee and depends on initial input from the interviewee during a live interview. For example, if a job applicant is asked to answer questions regarding all of his 9 previous jobs, then when this group of questions are employed, the questionnaire will ask to list each job and then will present that section the required 9 jobs with appropriate name labels.

The status for each QFU is dynamically determined during the live interview by a set of rules that were defined when the QFU was created. For example, for the question “How many drinks of alcoholic beverages do you have per day?” and with an question answer format allowing a single numerical answer, if a predefined limit of 2 drinks per day is exceeded, then a flag is set that marks this question as being abnormal.

The system uses a natural language, intuitive interface that allows these processes to be fulfilled without any programming skills. The server contains a master library of predefined and customized QFUs as well as QFUs sub-components. The system lets the user quickly define custom QFUs, groups of QFUs and sub-components containing interaction rules as tools to build questionnaires.

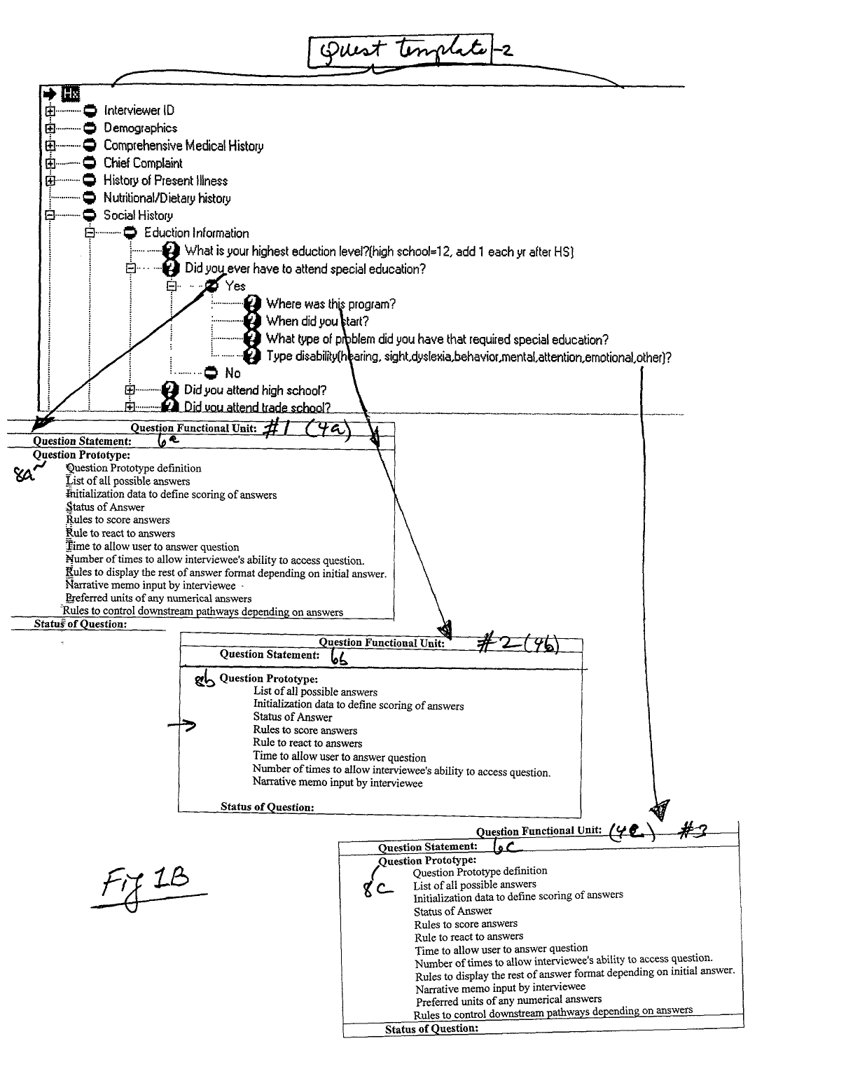

Referring now to FIG. 2A, a schematic flow chart of the tree structure of one of the embodiments will now be described. The system will build and maintain a library (12) of operational units called questionnaire templates, each of which contain a two dimensional array of questions that are represented by question functional units (QFUs). In the FIG. 2A, there are three (3) questionnaire templates represented. An interview is a questionnaire template that has been applied to a specific interviewee user.

For illustration purposes, consider questionnaire templates A, B, and C. For purposes of this disclosure, individual question functional units are also referred to as questions. The questionnaire template A has QFU 14, 16, 18. The questionnaire template B has QFUs 20, 22, 24. The questionnaire template C has QFUs 26, 28, 29.

Under questionnaire template A, the QFU 14 may ask if the user has a college degree. If the answer is yes, the system will present the user with the QFU 16. The QFU 16 may asked the user if a masters degree was obtained. If the answer is no, then the system takes the interviewee down another path to the next node which is represented by QFU 18B. If the answer is yes, then the system proceeds to QFU 18A, which may ask the user if he/she has received a doctorate. In the FIG. 2A, this is the last subset question in this array; thus, either a yes or no answer will end the traversing of this questionnaire template. The pathways illustrated above could not only lead to a single QFU but also a linear string of questions (i.e. QFU) or even to another entire complex, two dimensional array of QFU (i.e. questionnaire template). The methodology proceeds with the questionnaire template B. The system will ask the user a QFU 20.

Then, if the answer to the QFU 20 is no, the system will proceed to the no pathway after QFU 20. However, if the answer to QFU 20 is yes, then the system will traverse the yes pathway and ask the interviewee the QFU 22. If the answer is yes, the system proceeds to the QFU 24. If the answer is no, the system proceeds to the no pathway questions and/or downstream questionnaire templates.

If the QFU 24 was asked, the interviewee will answer either yes or no. In the event that the interviewee answers yes, then the system prompts the user with an answer form as will be set out in further detail later in the application.

If the QFU 24 was asked, then either a yes or no answer will loop the user back to the macro question C. If a node has a (+) sign, then it contains sublevels that can be accessed by clicking on that node. The sublevels will contain pathways and branches made up of QFUs and headings.

The process continues with the questionnaire template C. The system will ask the user the QFU (26) of template question C. Then, if the answer to the QFU 26 is no, the questionnaire is completed. However, if the answer is yes, the system will ask the user the QFU 28. If the answer is yes, the system proceeds to the QFU 29. If the answer is no, the system loops back and the questionnaire is completed.

If the QFU 29 was asked, the user will answer either yes or no. In the event that the user answers yes or no, the system loops back and the questionnaire is completed.

FIG. 2B is an exemplary questionnaire template library/data base depicting the tree structure of three selected questionnaire templates. Thus, QTA is labeled “Hx” and FIG. 2B shows a portion of its tree structure. The QTB is labeled “Hx Experiment” and FIG. 2B shows a portion of its tree structure. The QTC is labeled “Another BW Test” and FIG. 2B shows a portion of its tree structure.

FIG. 2C is a schematic flow chart of one embodiment of the database interactivemanagement system, which will now be described. The user will log in 30, with the log in being a security device well known in the art such as Windows NT security or any other user-password method. As understood by those of ordinary skill in the art, different levels of security will be allowed. Thus, some individuals will be allowed access to a particular set of files, records in files and various functions inside the system.

After access is allowed, there are three major components of the system which include the “Exit Interview System” 32, the “Maintenance of Interview System” 34, and the “Application of Interview System” 36. The “Application of Interview System” 36 would be deployment of an interview as a specific instance of a questionnaire template as set out by the teachings of this invention, thus, creating two dimensional arrays of QFU questions as seen in FIGS. 2A, 2B.

The “Maintenance of Interview System” 34 module will allow the client to create and maintain a library of individual QFU 38, simple groups of questions i.e. macros (40) and complex, two dimensional arrays as questionnaire templates (42). Groups of QFU as simple one dimensional lists are known as macro questions.

In other words, the client can copy data from the master library or create de novo, custom single QFUs or a plurality of QFUs in macro questions or questionnaire template arrays.

This data would be created at the discretion of the client based on the client's individual needs or could be drawn from a library of information that is typical for certain fields, e.g. medicine, law, engineering, etc.

Referring now specifically to FIG. 2D, the details of a QFU are set-out in the illustrated chart. The QFU comprises the question statement, question prototype, rules, help information, status of quesiton, language choices, and status of wheter QFU is currently active or archived. The QPT includes: definition, list of all possible answers, status of answer, time to allow user to answer question, number of times to allow interviewee's ability to access question, narrative memo input by interviewee, and preferred units of any numerical answers. The rules include: rules to display the rest of answer format depending on intial answer, rules to score answers, rule to react to answers, rules to control downstream pathways depending on answers, filter rules, data conditioning rules, and rules for linking to statistical analysis packages. The QFU will also include help information, status of question, language choices and wheter QFU is currently active or archived.

Referring again to FIG. 2C, the basic unit for information gathering, i.e. QFU, contained within the “Create/Maintain Individual Question” library (38 of FIG. 2C) would be created from combining multiple components that are needed to make a complete question, i.e. QFU. These components include a statement of the question, means for answering the question and what to do with the answer, etc. See FIG. 2C.

As noted earlier, to make creation of these objects easy, intuitive and to reduce errors, the client would use well known drop/drag and tree control objects to create or edit components or entire questionnaires.

All questions are created utilizing the QFU which is a complex device which serves as a template tool for creating any question and defining answer input scenarios and how to respond to the answers.

The question functional unit includes a means for defining a statement of the question (41) as well as the answer format. The answer format is a definition of the type of answer that is appropriate for the question and a means for defining the method of answering 43. These types of answer scenarios are categorized by QPT numbers or Question Prototype numbers. This includes providing and defining dialog boxes with various entries and choices for a set of possible Question Prototypes.

For instance, the user could answer a question by defining the severity of a condition based on a scale of 1 to 10 (QPT=6). Alternatively, a question could be answered by prompting the user for narrative text in order to describe features, conditions, etc. (QPT=2). Certainly, many answer scenarios are currently defined and other scenarios can be added in the future. As an illustration, QPT=0 (category only); QPT=1 (multiple choice); QPT=2 (memo or text); QPT=3 (single choice); QPT=4 (dual choice); QPT=5 (numerical ratio); QPT=6 (ranking scale); QPT=7 (yes/no); QPT=8 (graphics); QPT=9 (date); QPT=10 (date range); QPT=11 (yes/no severity with frequency duration).

Once a QFU is built or copied from the library, it is placed inside a two dimensional tree structure to build a questionnaire template. By inserting and arranging a collection of QFU in a tree structure using drag and drop methods, a complete questionnaire can be built.

Module 43 (QPT) further gives the user the ability to create and modify individual question functional units by selecting the method by which that question will be answered, e.g. yes/no, multiple choice, dates, number ranges, etc. Module 43 also allows the user to define all variables, functions, filters and rules that are needed to make a complete QFU. (See FIG. 2C).

The user will further define and provide a set of control means i.e rules of reaction, to the answers(44). The controls include all possible means whereby the program will react to the answers provided by the interviewee. For example, some rules allow the user to define the path through the questionnaire that will be taken by a particular answer, i.e. if the person being interviewed answers yes to a certain question, then the system proceeds to the next question in one pathway; if the answer is no, then the system proceeds to the next question in a different downstream pathway, etc. This allows the interviewee to avoid inappropriate questions that are not relevant once a certain question has been answered. For example, if an interviewee indicates that she is a female below the age of 10, then certain questions would not be appropriate and would be excluded from her interview. However, questions are present in the questionnaire template that would be appropriate for other ages and males but all of the inappropriate questions are then pruned from the tree structure so that they will not appear in the actual interview. Other reactions include real time scoring of the answers or launching specific software programs for each answer provided by the user. This list is illustrative and can be expanded to any degree as needed.

Once a QFU has been finished, it is saved 46 into the master question library. It can then be used in the future by any user and inserted into macro questions or questionnaire templates.

Once the user has completed the questionnaire template it can be deployed or run as an interview for a specific interviewee. The entire questionnaire template can be saved and stored 64 as a file for future use and can save time and reduce errors by utilizing this work product for future similar questionnaires. An unlimited number of questionnaire templates can be saved as files thus providing a rich resource for future development of new questionnaires or simply reusing and modifying older questionnaire templates. Each of these files 64 can be retrieved and used by the user.

As noted earlier, each questionnaire template may be made up of a collection of question macros or multiple question functional units. The user can retrieve and edit individual question functional units 38, question macros 40 or questionnaire templates 42 in accordance with the teachings of this invention.

The retrieval, creation and editing of individual macro questions will now be described in greater detail with reference to the step 40. The user could also create, retrieve and edit individual question macro as seen in step 48 to it by personally editing subset questions contained therein. Once macro questions are completed, they can be copied and pasted into any questionnaire template. The user could also delete 50 a macro question or delete one of the QFU that makes up the macro question. Additionally, the user could edit 52 the macro question. Once the user has completed his/her editing, the macro question may replace the previously retrieved macro question, or the user may save as a whole new macro question 54.

With reference to the questionnaire templates 42, the system herein described allows the user to insert 56 or delete 58 a specific QFU, macro question or a previously prepared questionnaire template into any position inside a new questionnaire template 42. Since each user and each questionnaire will have different needs, this unique feature of the system allows the user maximum speed and flexibility in creating questionnaire templates by utilizing various previously created and tested, single question functional units or groups of question functional units.

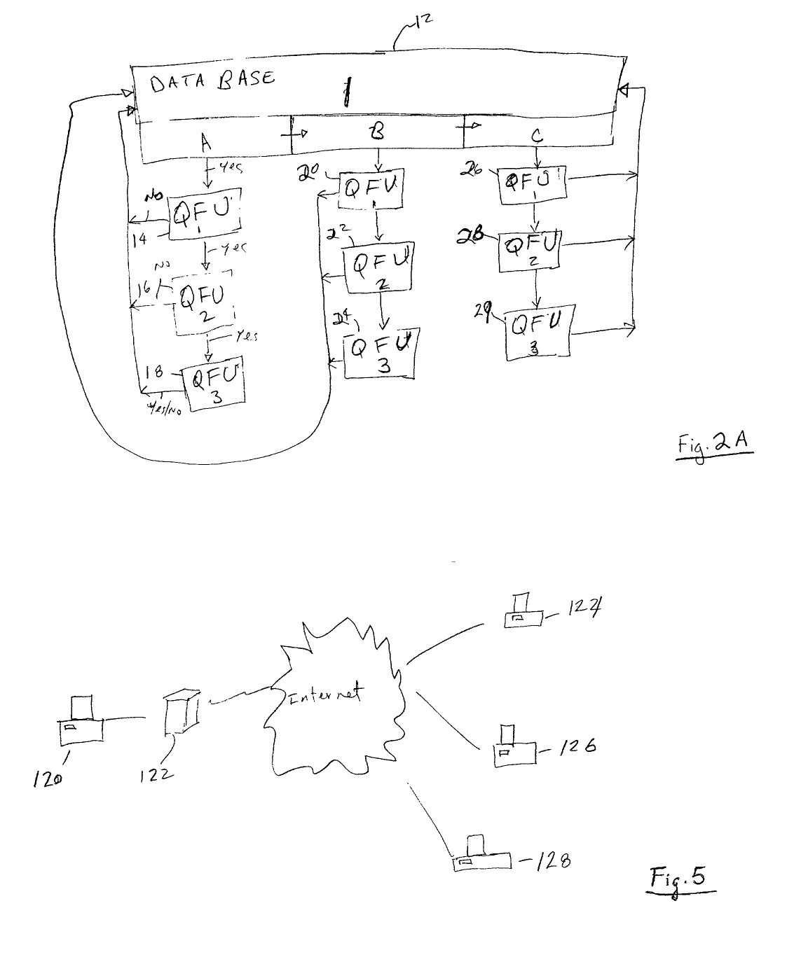

Create/edit questionnaire templates module 42 allows the user to order 60 and define pathways 62 that displays the relative position of the individual question functional units inside the questionnaire template. Groups of individual question functional units (macro questions) or single question functional units (QFU) or previously created Questionnaire templates can be inserted, deleted or moved about via drag and drop techniques inside a main questionnaire template. It should be noted that examples of the tree structure of QFU inside a questionnaire template are described with reference to FIGS. 3A and 3B. The system further gives the user the ability to save the questionnaire as another file with the same name and then to edit that new file to allow for rapid development of new questionnaire templates by using previously developed templates 64.

Reference is now made to FIG. 3A which is a schematic flow chart of the tree structure of QFU and various question macros inside a questionnaire template. Specific and separate macro questions are denoted by the letters A, B, C, and D respectively. In accordance with the teachings of the present invention, the macro question A will have QFUs denoted by the numbers 70, 72, 74. The QFUs of FIG. 3A are similar to the QFUs previously mentioned in the discussion of FIG. 1. The macro question B will have QFUs denoted by the numbers 76, 78, 80. The macro question C will have QFUs denoted by the numbers 82, 84, 86. The macro question D will have three QFUs.

In FIG. 3B, a schematic flow chart of the tree structure path of a single questionnaire template is illustrated. It is to be understood that the subset QFUs may very easily branch off into other sets. Thus, the individual question template path includes the QFUs 70, 72, 74. The QFUs 74 may then branch out to another QFUs 88, 90, 92. For instance, the QFUs of questionnaire template “A” may deal with education. Thus, question 70 may ask if you finished high school. Question 72 may ask if you finished college. Question 74 may ask if you have an advanced degree. If the answer is yes, question 88 ask what school, question 90 ask what year, question 92 ask the degree formally awarded. Question 92 further branches into QFUs 94, 96 which is a node in the tree structure which represents insertion of a secondary questionnaire template. Hence, question 94 may ask your principal research professor, question 96 may ask if a thesis was presented and the subset question 98 may ask the title of the paper which you provide in a text format. Questions 94, 96, and 98 would be automatically repeated if you had multiple degrees.

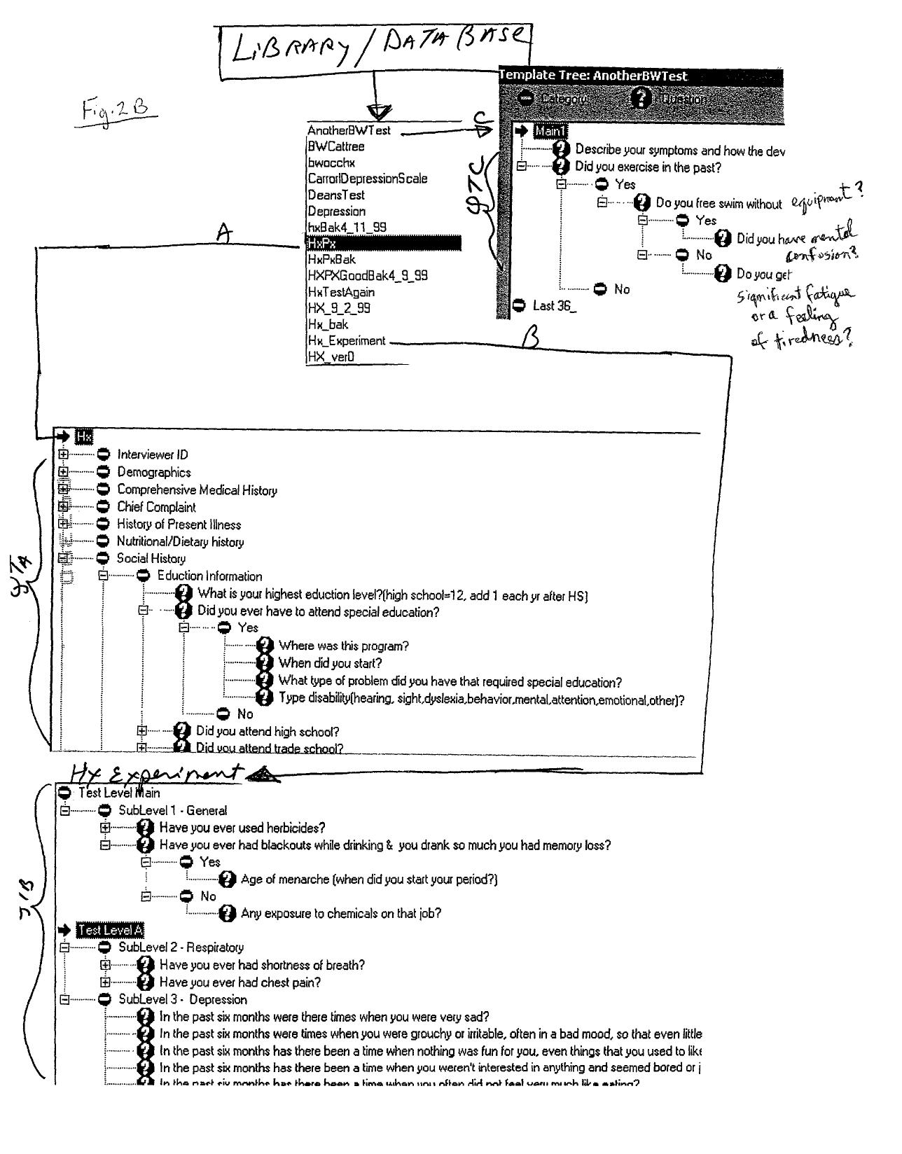

Once a questionnaire template is completed, it is saved into a database 31 for future use. Each questionnaire template is an software object that can be used as a resource to create applications (i.e. interviews). With reference to FIG. 4, a schematic flow chart of an interview allowing for reactions to answers will now be described. Thus, the operator chooses a specific questionnaire interview 100 from the database 31. The person answering the questionnaire 100 will provide answers 102. Each possible answer to a QFU has programmed responses that were defined during the creation of the QFU, wherein a response 104 initiates an predetermined action with the system having means for executing that action.

For instance, if an interview question is “Are you currently feeling chest pains?”, then that question statement is part of a QFU that is inside an interview. That QFU will have a predetermined response to the “Yes” and “No” answers that will be triggered by each respective answer.

The database 31 will contain that specific question within that interview with the answer “Yes”, and that answer will initiate a response stored in that QFU. In this case the response would be to send a specific e-mail message 106 to a specific recipient. Alternatively, a predetermined response to another specific answer inside a specific QFU being answered during an interview, could trigger a browser to link to a specific universal resource locator (URL).

Each specific QFU contains control means for determining real time scoring (108) of each question during an interview as well as what action to take for each interviewee's possible answers. This feature makes the system useful for tests or any applications whereby the interviewee's answers are scored by comparison to a standard set of answers. In this system, those standard answers are stored with each question.

Additionally, a user may perform statistical analysis 109 on the interviewee's answers compared to a reference population or compared to all members in a defined group by processing the data within the database 31. The results of the statistical analysis 109 can be stored for later examination. The system provides a means by which answers are to be linked to third party statistical analysis programs.

These types of statistical studies are useful for a variety of fields including but not limited to medical, scientific, engineering, epidemiology, opinion polls, legal, surveys, etc. Standardized test can be analyzed in a multitude of useful ways. Additionally, test can be administered as part of a training technique, for instance, an Engineer-In-Training test can be given to prospective engineers so that they take the test, and statistically analyze their strengths and weaknesses. Since the responses to each question are stored inside the QFU, these tests give maximal capacity and significant improvements in adaptive testing methods whereby the test adapts to the interviewee in a predetermined manner.

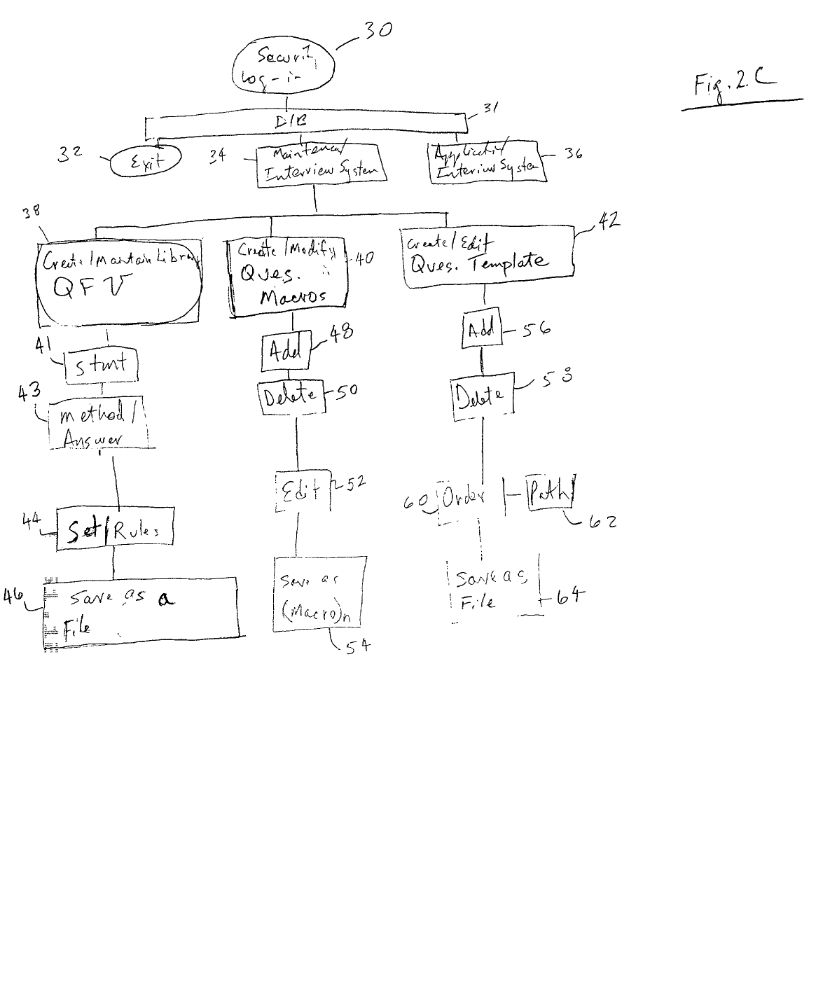

Referring now to FIG. 5, a schematic flow chart of an embodiment linked with a global network of computers will now be described. FIG. 5 depicts one embodiment of the distributed architecture of the present invention. A computer 120 is utilized for storing, processing and running the software for the novel system. Computer 120 is readily available from commercial sources such as Dell, Apple, Sun, etc. The computer 120 will be connected by conventional means to a server 122. The actual master program is stored on the server 122.

The computer 120 can down load the master program and perform maintenance, etc.

In one embodiment, the computer 120 and the server 122 can be the same device. The server 122 is connected to a network, e.g. private intranet, Internet, virtual private network, etc. Hence, individual user computer 124, 126, 128, etc. can be linked to the Internet which in turn will be linked to the server 122. Thus, the interview with appropriate application programs need to run the interview are down loaded to the individual computer means 124, 126, 128. The administrative users can access the master program and interact with the program as previously described in FIGS. 1, 2, 3 and 4.

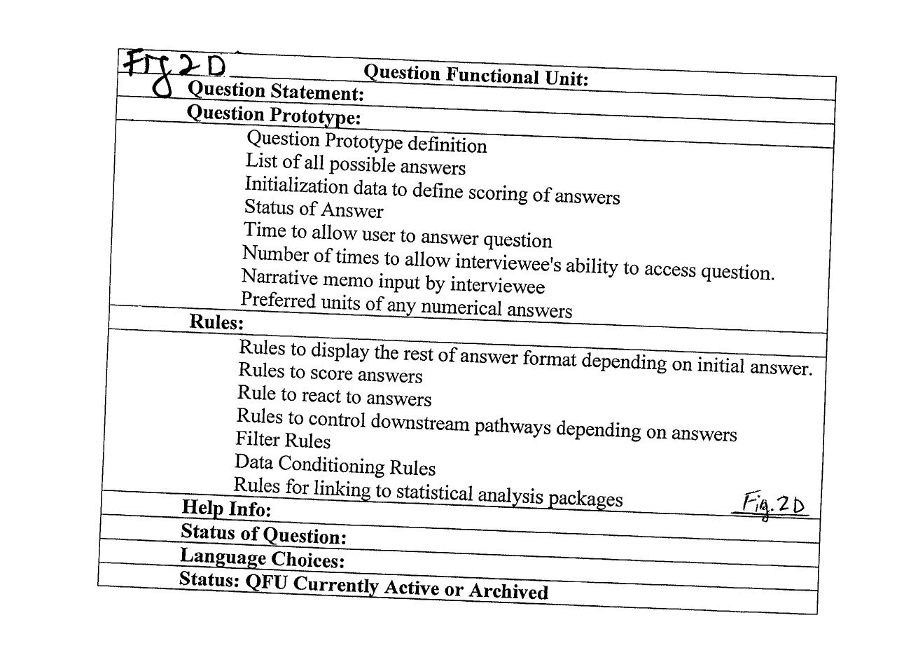

In FIG. 6, a schematic flow chart of an embodiment of a closed, secure network of computers will now be described. The embodiment of FIG. 6 is an alternate distributed architecture as compared to the architecture of FIG. 5. Thus, the server 140 has contained thereon the database 31. In order for user 142 to access the questionnaire database 31, the user 142 must log in using the security access means 144. The security access means allows selective entry into the database 31 based on the authorized level of security, as previously mentioned. Thus, once access has been allowed to an appropriate level, the user 142 can access the relevant questionnaire template, tools and interviews.

The FIG. 6 shows that multiple users (150, 152, 154) at multiple sites and work stations may access the questionnaire system via various networks, however all must log in via security a module that will identify the user and then determine the types of activities and functions that user may utilize as well as what data may be accessed, added, edited or deleted.

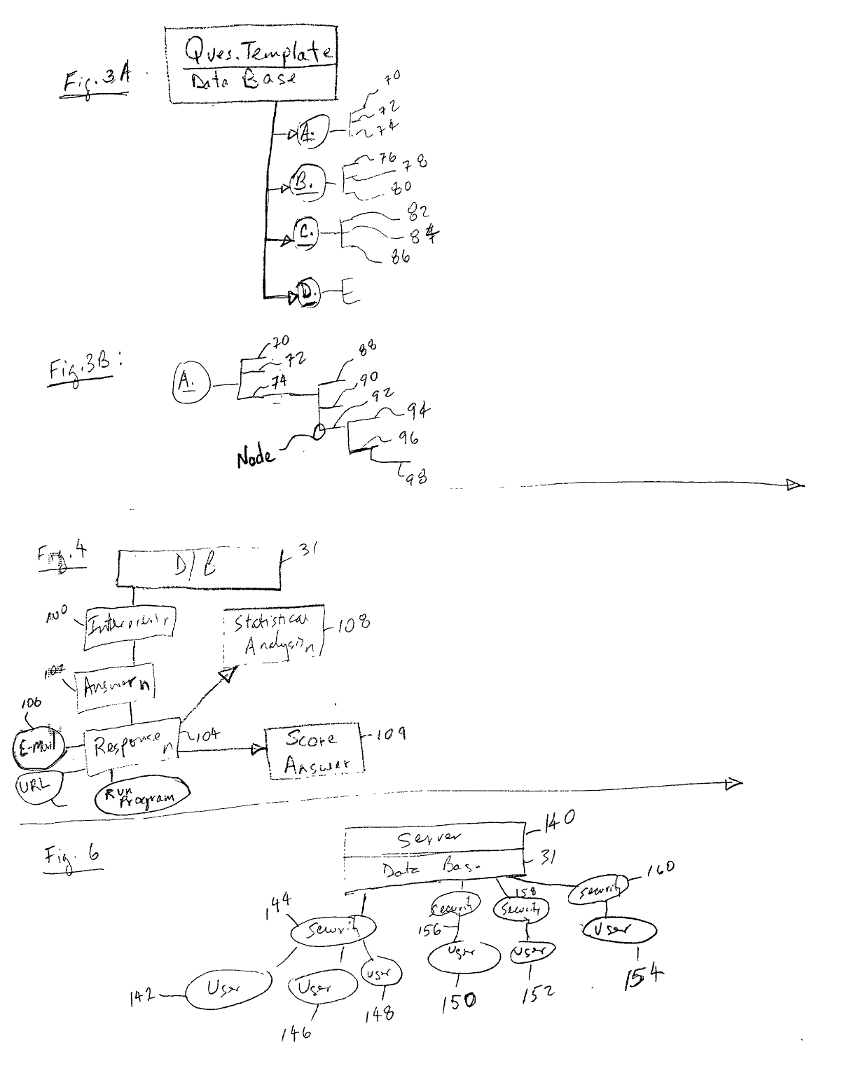

FIG. 7A is a schematic representation of a file 170 that contains a plurality of macro question names, with the individual macro question names units being numerically listed as 1, 2, 3, 4, 5, 6, 7, and 8. Each macro question has associated therewith a plurality of subset question functional units as previously discussed. The client may create copy, edit, add or delete macro question names as well as to copy, edit, add or delete individual question functional units that make up each macro question. Each macro question is a collection of QFUs, as set out in FIG. 7B.

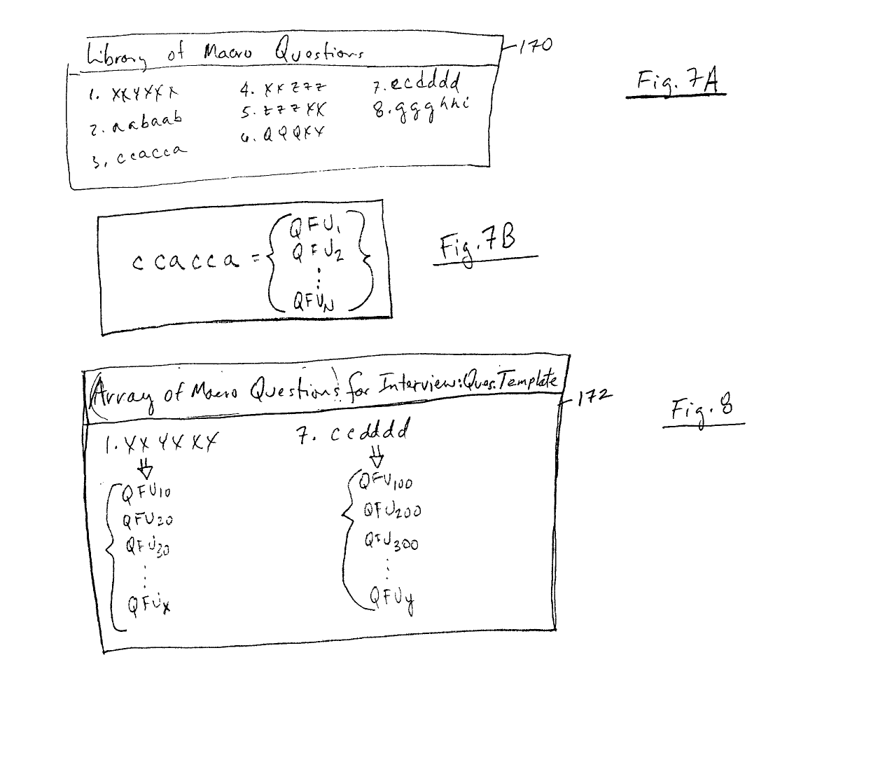

In FIG. 8, a schematic representation of a question template file 172 is illustrated. The file 172 contains two macro questions, i.e. macro question “xxyxxx” and macro question “ccdddd” as would be inserted inside a questionnaire template. The questionnaire system then substitutes the QFU components (i.e. QFU10, QFU20, QFU30 . . . QFUx for macro question “xxyxxx” and QFU100, QFU200, QFU300 . . . QFUy for macro question “ccdddd”) of each macro question into the questionnaire template at that location in the questionnaire template array.

In accordance with the teachings of the present invention, a questionnaire template is a modifiable object in the data library that is a tool to be modified, to build other questionnaire templates or to create actual interviews for specific interviewees. Once an interview has been created as an instance of a questionnaire template, then the interview can be deployed over a network and provided to an interviewee to run.

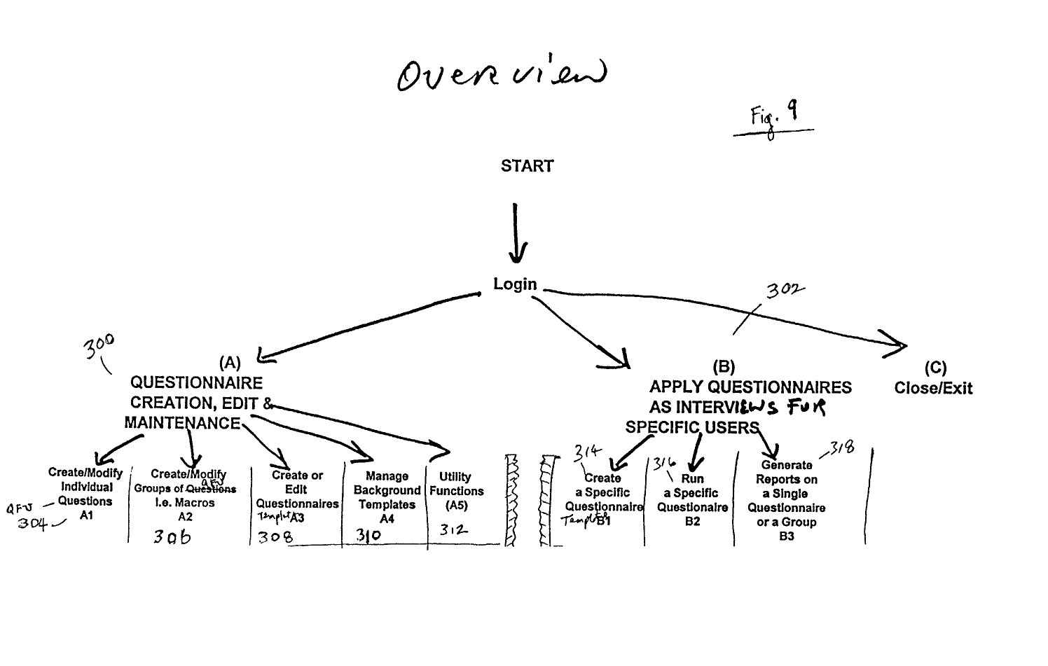

The most preferred embodiment of the invention is presented in FIGS. 9 through 18. In this most preferred embodiment, the method and system is divided into two basic parts, as seen in FIG. 9, which is a block diagram of the most preferred embodiment of the system. The first part 300 contains all of the functions and data necessary to create and maintain the infrastructure that is needed to create and deploy a questionnaire template. The second part 302 contains all of the functions necessary to allow a user to apply a questionnaire template as an actual interview, to analyze the answers and to generate reports.

The maintenance section 300 includes subroutines that allows the user to create or edit 304 the components that make up the QFUs. Those components include a question statement, means for answering the question, filters, data conditioning, initialization of variables, scoring, descriptive attributes, etc. The system will require the questionnaire administrator to further define the sub components of each QFU. In order to create or edit individual question functional units, the system allows for the defining of the each sub component used to compose the QFU and then assembling those sub components to create Question Functional Units.

The first such sub component of the QFU is the question statement which is the rhetorical part of a question, i.e. a statement of the question that in itself does not allow for an answer.

The second sub component is Question Prototype that defines the answer format method by which that question statement can be answered and thus the question statement is no longer rhetorical because it now has a means for being answered. For example, the question statement “What type of food do you like?” can be answered by one of several answer format methods, e.g. multiple choice or a free form narrative. After the answer format method is defined by selecting a numbered question prototype (QPT) from a list of possible answer format methods, then specific content for the multiple choice answers can be created. For example, the question “What type of food do you like?” with a multiple choice QPT could generate an infinite set of specific QFU depending on the administrator's selection of multiple choice answers. In this system, the QPT number for multiple choice is 1.

The general form for a QFU is as follows:

(I) Question statement=“xxxxxx”

(ii) Answer format as defined by QPT (answer format) selection

(iii) Data to initialize QPT answer choices

(iv) Data to initialize secondary answer format structure

(v) Category index

(vi) Software or links to define reactions that are to be mapped onto each possible answer outcome and that will be activated when that answer is chosen by interviewee.

Therefore this specific QFU is beginning to take the form:

(I) Question statement=“What type of food do you like?”

(ii) QPT=1 (Multiple Choice)

(iii) For this step, here are three examples of data for the question statement:

Which data is chosen is determined by the administrator who creates the QFU and each unique choice of data is saved as a unique QFU in the question library database. Thus this data would result in three unique QFU being created and saved, each with the same question statement.

QFU 1: {a) chicken,

b) hotdogs,

c) boudin,

d) hamburger,

e) mutton}

or

QFU 2: {1) Lebanese,

2) French,

3) Russian,

4) Italian,

5) Chinese}

or

QFU 3: {I) fried,

ii) baked,

iii) raw,

iv) poached}

The system also allows each QFU to have a category index delineation. Each category index, e.g. food, law, medicine, petroleum production, missile launches, etc. is defined as a part of a tree structure of categories and sub categories whereby the position of an item in that tree is represented as a pathway through the tree structure that reveals a QFU's relationship to the general category database. These relationships are useful to index each QFU in building questionnaire templates to classify questions. The novel system allows the user to define such category structure for future use as well as to label actual QFU. A means for creating the tree structure utilizes the well known drop and drag techniques that allows the administrative user to build a hierarchical tree and drop and drag categories where the administrative user deems appropriate. These indices are also useful in generating reports or limiting questions during interviews or searches or statistical analysis by allowing filtering for classes or subclasses of questions for any purpose.

The system requires initialization of the data needed to make each answer format, contained in each QFU, functional. This includes data parameters to allow real time scoring of the answers and to store the scores as flags that can be utilized later to generate reports or composite scores for that interviewee or to be used by statistical packages. One example of this real time scoring would be to have each question scored as to normality vs abnormality vs neutral for each question in a medical questionnaire.

Once the question statement inside a QFU has been created and an answer method has been assigned (QPT), then the detailed facts required by the sub components of that QPT answer format need to be defined. This includes data needed to score that question (QFU), e.g. Yes=Abnormal, No=Normal, All other=Neutral.

By defining criteria for scoring the interviewee's answer e.g. normality or abnormality, an administrator can cause a particular answer by the interviewee to be scored and the results stored as a memory variable. This new data triggers a software response to any specific answer for any specific question (QFU), e.g. launch a subroutine, E-mail or activate browsers, etc.

The data from this scoring process can also be used later to calculate a composite score for that interviewee or can be used by any statistical analysis package or by report generators to filter out large volumes of non significant data and to focus on pertinent answers. For example, a human resource counselor (HRC) in a company could define certain answers for certain questions as having a high level of importance and all answers as having a good, bad or indifferent level of significance. If the interviewee answers a high level question, e.g. indicates that he/she is underage, or has been convicted of a felony or has been arrested for drug abuse problems, etc, then the system will set flags during the interview to indicate that these answers are problematic or could even terminate the interview process at that moment. The interview could consist of thousands of questions that could take hours to review. However, the human resource counselor could initially ask the system to issue a report of only those questions that were flagged as being highly problematic or that showed exceptionally good qualities that are most predictive of good job performance, thus saving time and increasing accuracy of evaluating interview data. The HRC could then focus on those questions that had the highest impact on his decision making and could elect to not take the time to read through volumes of questions and answers that would not effect his decision making. As that companies policies change, the HRC could edit the questionnaire templates thus changing all future interviews appropriately.

Another part of the process to create/modify individual QFUs, the system will allow setting a data flag inside each QFU regarding its “active or inactive” status.

If the QFU status is “active” then the QFU is available to be added to questionnaire templates. If the QFU status is “inactive” then this specific QFU is archived and is not to be used anymore and is only available in reference to questionnaire templates and interviewees created prior to the instant this QFU was set to “inactive” status.

For instance, if a question (QFU) is deemed to be no longer appropriate to use for any reason, then a flag can be set inside that QFU by the administrator to indicate that it is now “inactive”. In the future, that question (QFU) will be available only as an archival record and can not be used by lower level users in new questionnaire templates.

The system further includes the capability to create and modify question macros 306 which includes adding or deleting individual QFUs that are stored together inside a specific question macro which is a simple QFU list. To create a question macro, the macro is first given a name and the specific QFUs from the question library are selected and inserted inside the question macro list.

The system further includes the create and/or edit questionnaire template module 308. Thus, the user can create a two dimensional questionnaire template array by removing or adding categories as well as any QFU from the question library. The methods used in this system allows data to be arranged inside the questionnaire template by drop or drag techniques that allows you to highlight a specific category name, specific QFU or entire pathways containing arrays of QFU and drag it to the correct position and then to drop it into place.

Also, the user can insert previously created questionnaire templates as secondary questionnaire templates into other questionnaires allowing complex, large questionnaires to be rapidly built from complex, error free and well test components.

Furthermore, an important feature of this system is to allow QFU to act as logic gates to modify an interview in real time by controlling the allowed pathways through the interview. This is done by coupling a “yes/no” or “true/false” logic path gate with a specific QFU whose answer will be needed to control the downstream questions. In such cases a QFU with a logic gate is placed at a node that is a bifurcation point in a questionnaire template pathway and where the questions downstream from that node can take one of two pathways. Each pathway contains any number of QFU and branches whereby all questions in that pathway are logically related and appropriate for either one or the other answer to the nodal QFU's answer. The logic gate will then allow the interviewee's answer to disable one inappropriate pathway and enable the other appropriate pathway.

Further, defining default information for the QFU sub-components is allowed by the system. This is possible since for every type of QPT and its many sub-components, there are likely to be a set of facts that are frequently used when initializing a new QFUs. The system herein disclosed allows the user to define the default values so that the tedious process of defining the exact facts used in building a QFU do not have to be repeated. The default values are predefined sets of choices used to initialize the data associated with the QPT sub-component of the QFU.

The manage background template function 310 will now be explained. A primary questionnaire template is intended to be the major portion of an actual questionnaire template that is used to generate an actual interview. A secondary questionnaire template is also a questionnaire template from the questionnaire template library, however it is used with a background template marker to be inserted into the primary questionnaire template at a later time to create a third questionnaire template. A secondary questionnaire template is to be substituted multiple times inside of a primary questionnaire template with interviewee defined labels to allow the primary questionnaire to be customized in real time during an interview to customize the interview to the unique needs of each interviewee.

The background template is an object that contains an administrator defined name to identify itself to the system as well as a name to be displayed to the interviewee during an interview and several labels to be displayed to the interviewee. These labels prompt the interviewee as to what information needs to be input. This information will be used to label the multiple copies of the secondary questionnaire that is inserted at that node in the primary questionnaire. The background template will be discussed in greater detail later in the application.

As used herein, a background template is a marker placed inside a primary questionnaire template at a specific nodal position inside the tree structure of a specific questionnaire template and that triggers the program during an interview to prompt the interviewee for information and then to insert multiple secondary questionnaire templates based on that information.

When that specific QFU question plus background template marker is encountered by an interviewee who is traversing the tree structure of QFU during an interview, then the system does the following:

(a) the background template is activated and deploys a subroutine that will look up the category labels (parent, secondary, tertiary, date range) to be used (b) open an input window that is labeled with category label data to allow repetitious input of information from the interviewee; c) This process cycles through the collection of this data for any number of events (N) as determined by the input from the interviewee until the interviewee is finished inputting data;

(d) then locate the proper secondary questionnaire template associated with this background template name;

(e) copy the secondary questionnaire template “N” times

(f) insert them into the live interview that was based on the primary questionnaire template;

(g) appropriate labels from the data that was just collected from the interviewee;

(h) then present all of the new questions found in the secondary questionnaire template to the interviewee from inside the live interview;

(I) lastly, the system automatically saves the above data regarding the new questions and any answers provided by the interviewee.

The maintenance section 300 also contains the utility function subroutines 312, which deals with maintenance functions. The utility functions subroutine 312 will be described in greater detail later in the application.

In the questionnaire application section 302, the questionnaire templates created from the section 300/308 can be applied as an interview for a specific interviewee. Thus, the system allows for the creation of a specific interview 314, the ability to run the specific interview 316, and the capability to generate reports 318 from the data gathered by the interviews.

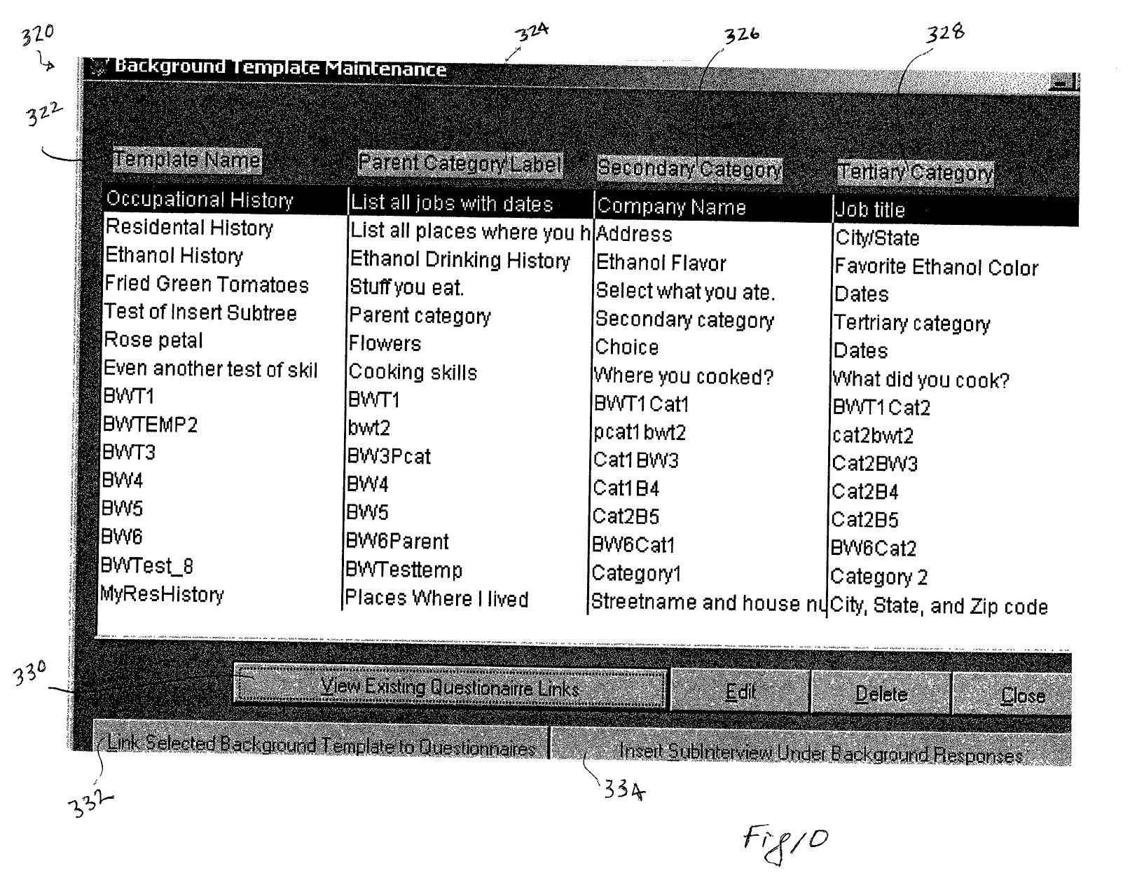

Referring to FIG. 10, the background template maintenance screen 320 will now be described. Screen 320 shows the background template names 322 (which is used within the program) with their associated background template category names, i.e. parent, secondary and tertiary categories. The parent category label 324 is the label shown to the interviewee to indicate where the background template marker has been placed and to reveal what type of data is to be input.

When a background template is created it also requires secondary category 326 and tertiary category 328 names which are also to be displayed to the interviewee during an interview to prompt the interviewee to input data that will be used as labels for each copy of that section of questions. Hence, a background template will have a name as well as a parent, secondary and tertiary category labels.

In order for the administrator to create a new background template, the following steps are applicable.

The first step is to give the background template a name that is used internally to the system and is not displayed to the interviewee. This allows the administrative user to assign a name to the background template marker for which it will be referred to in the future inside the program. For example, “occupational history template #121” can be a name for a background template marker dealing with an interviewee's job history. The interviewee never sees the background template name because it is only used as a marker inside the program to indicate when and where the background template subroutine will need to be activated from within the primary questionnaire template.

The second step is to label the parent category; this is an administrative user defined label that appears in the primary questionnaire template and which is visible to the interviewee as a heading announcing the general topic for which the interviewee is about to input data. Example: parent category=“Work history”.

The third step is to label the secondary category. This is an administrative user defined response category that is the name for the main category topic to be input by the interviewee during the live interview. Example: secondary category=“name of employer or company name”.

The fourth step is to label the tertiary category, which is another administrative user defined response category that will appear to the interviewee as another topic to be entered to help uniquely describe the input data. For example: tertiary category=“job title”.

In the fifth step, the administrative user is given an option as to indicate whether a date range data should be input by the interviewee. This step allows the interviewee to enter a data range to be associated with the above categories to help make each set of input data unique.

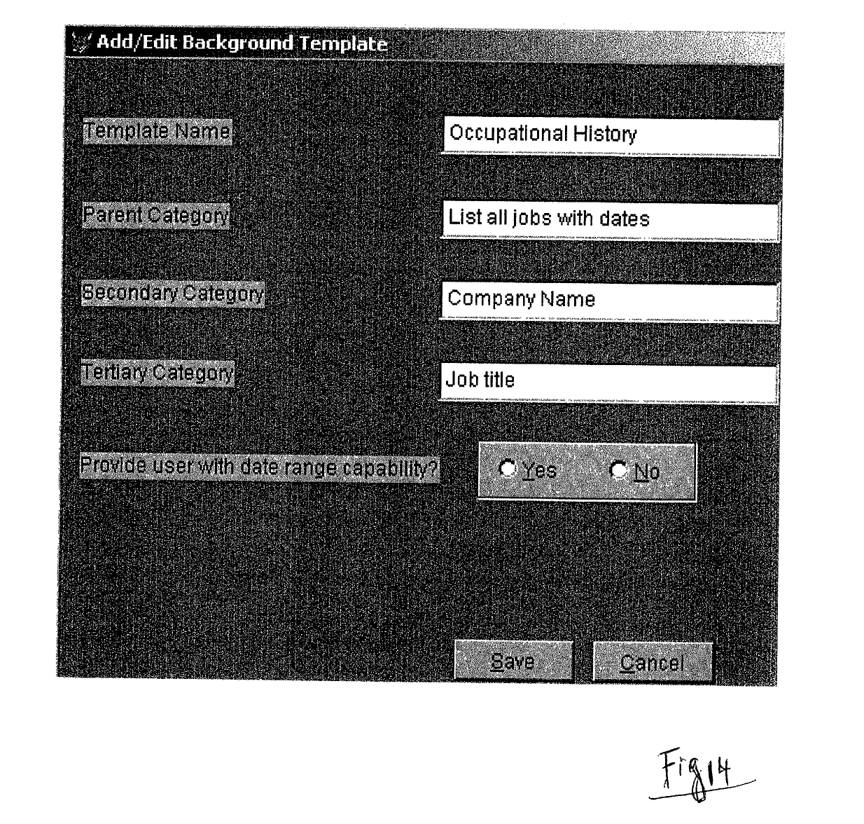

As seen in FIG. 14, an edit screen is depicted which allows the administrative user to add and/or edit data profile on a particular background template marker. This data is used to prompt an interviewee during an interview. For the above example background template: name=“Occupational History 121”; label the parent category=“List all jobs with dates”; label the secondary category=“Company name”, label the tertiary category=“Job titles”, date range category. The background template marker “Occupational History” is placed inside a primary questionnaire template and an instance of that primary questionnaire template is used to create an interview.

When the interviewee is running an interview and encounters the background template marker “Occupational History 121”, the interviewee sees the comment “List all jobs with dates” and the opening of data entry windows allowing entry of the data required by the data profile described above in this paragraph. An example of this data profile for an example background template is listed below:

Background template:

name=“Occupational history # 121”

parent category=“List all jobs with dates”

secondary category 1=“employer company name”

tertiary category 2=“job title”

Date Range=date range if appropriate

An example of data for the hypothetical background template “Occupational history # 121” is as follows:

Parent category: “List all jobs with dates”

Secondary Category 1: “employer company name=” xyx oil company

Tertiary Category 1: “job title=” rough neck

Date Range Category 1: Jan. 2, 1984 to Feb. 9, 1986

Parent category: “List all jobs with dates”

Secondary Category 2: US Navy

Tertiary Category 2: job title=navigator

Date Range Category 2: date range Jan. 8, 1987 to Sep. 8, 1989

Parent category: “List all jobs with dates”

Secondary Category 3: employer=gulf oil company

Tertiary Category 3: job title=electronics technician

Date Range Category 3: date range Mar. 4, 1995 to Jan. 11, 1998

Parent category: “List all jobs with dates”

Secondary Category 4: employer=Wal Mart

Tertiary Category 4: job title=Sales Clerk

Date Range Category 4: date range Mar. 12, 1998 to Sep. 22, 2000

The number of cycles (N) for this data is equal to four (4) and therefore the associated occupational history sub questionnaire template is inserted in the live interview four (4) times with the above labels. The interviewee then gets to answer one standard set of questions separately for each of the four events.

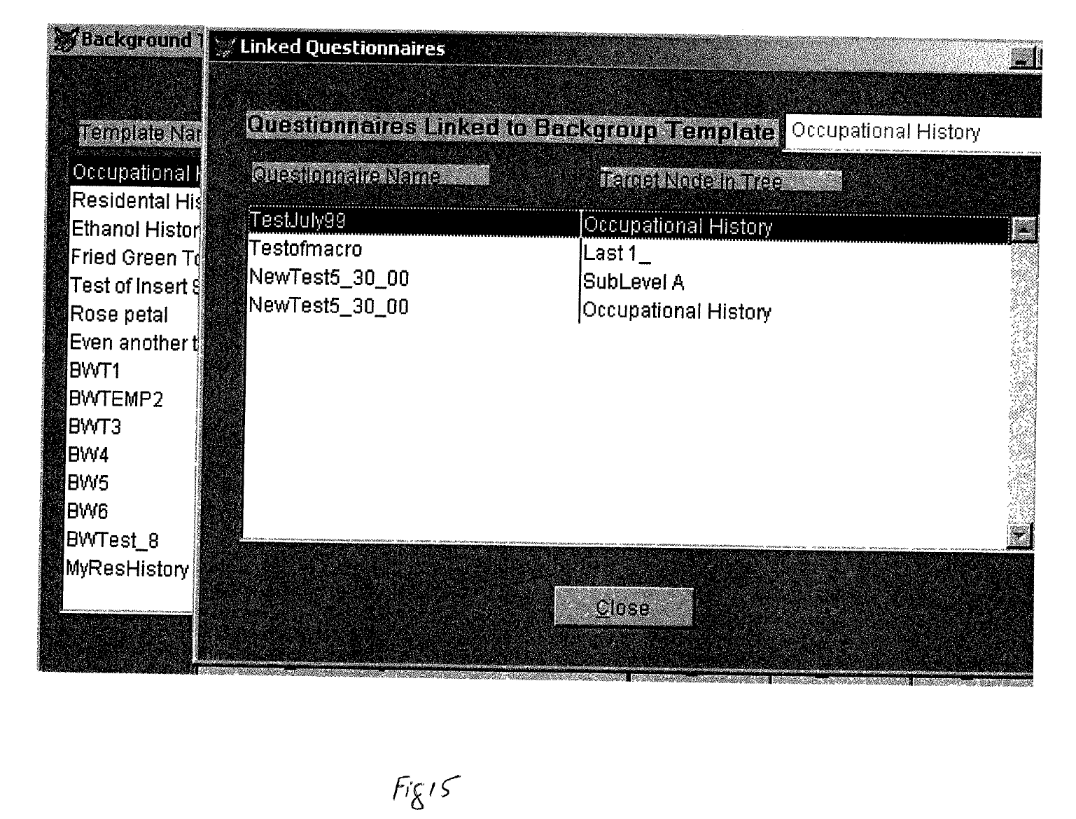

Referring again to FIG. 10, the “View existing questionnaire links” 330 button allows the administrative user to see what primary questionnaire templates have been linked to what background template markers and where that background template marker is located in the primary questionnaire template tree structure. (See also FIG. 15).

A primary questionnaire template is the main questionnaire template and a secondary questionnaire template is a template that is to be inserted multiple times inside the primary questionnaire template at the background template marker.

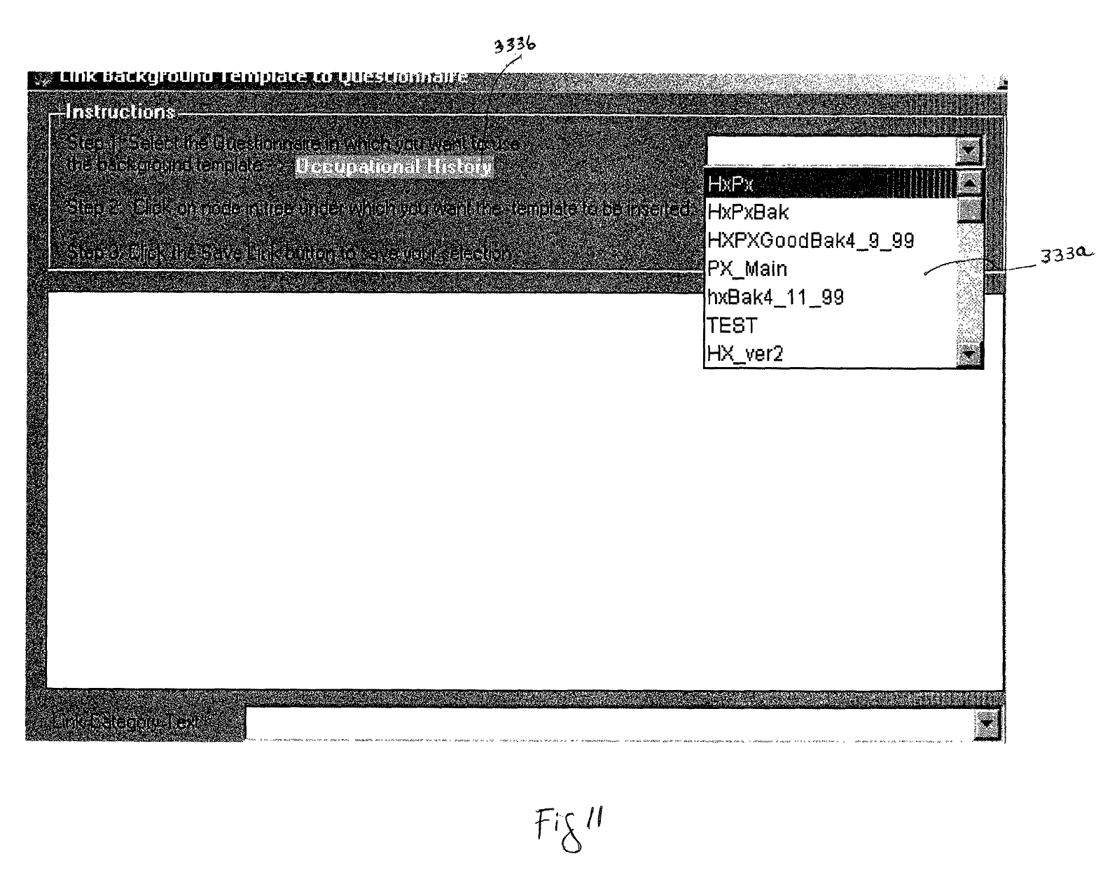

The first step is to select a background template name (See FIG. 10) and then to use the “Link selected background template to questionnaire” 332 button to allow the administrative user to select a primary questionnaire template. See also FIG. 11 which shows the list of primary questionnaires 333a, and shows the background template “occupational history” 333b that was chosen.

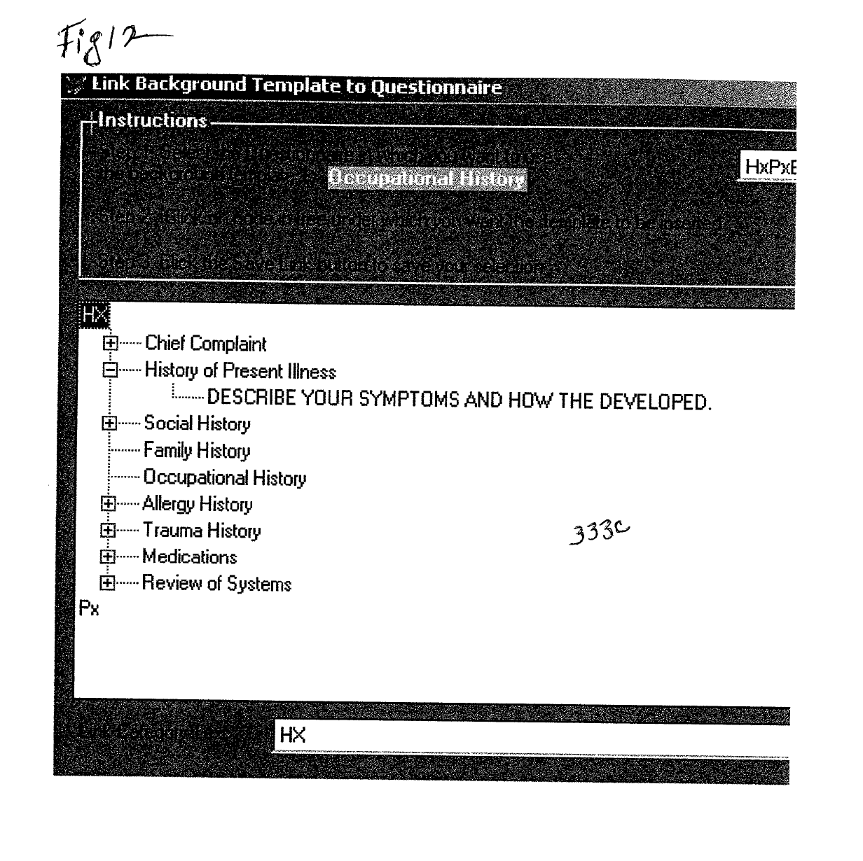

The second step is shown in FIG. 12 where the node or position inside the primary questionnaire template tree (where the secondary questionnaire template is to be located) is chosen thus linking the background template name (marker) to a primary questionnaire template. The tree structure is shown at 333c—see FIG. 12.

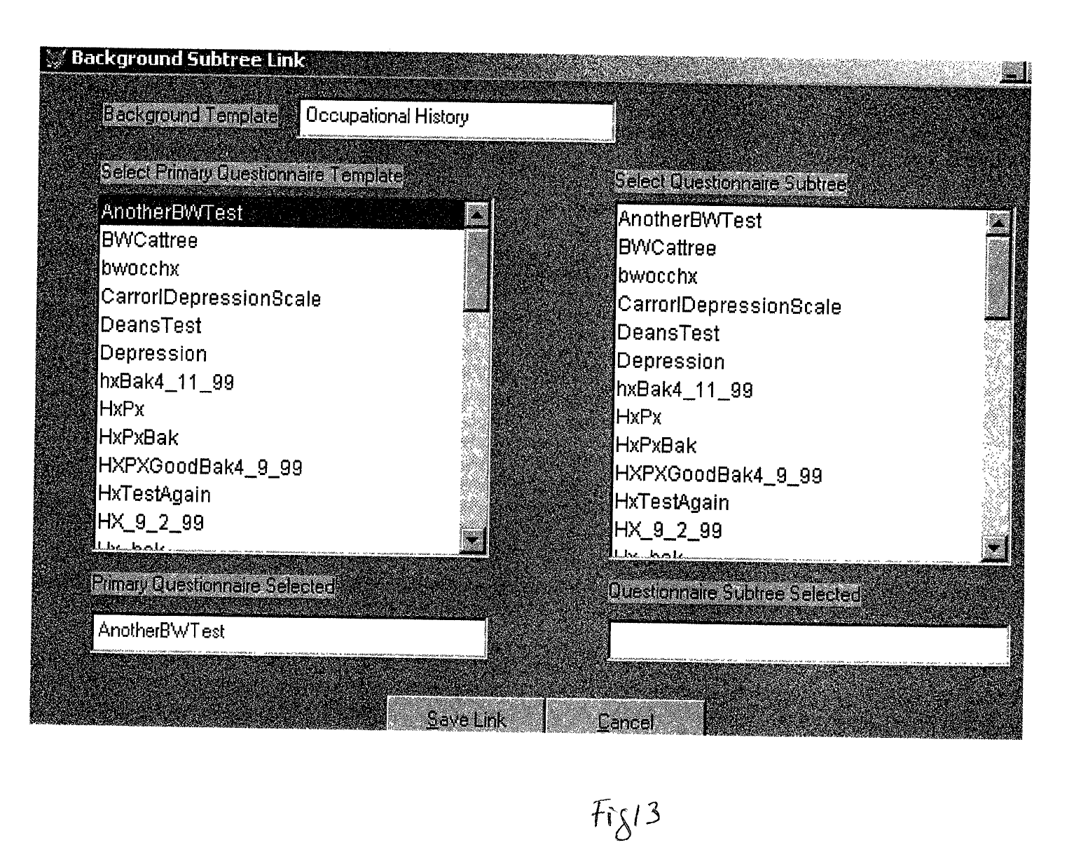

In the third and final step, the “Insert sub-interview (secondary) under background response” button 334 allows the user to select a primary questionnaire template and to link it to the secondary questionnaire template at the background template marker that has already been inserted inside the primary questionnaire template. (See FIG. 13).

This completes the link between the specific primary questionnaire template to a background template name (marker) which in turn links to a specific secondary questionnaire template.

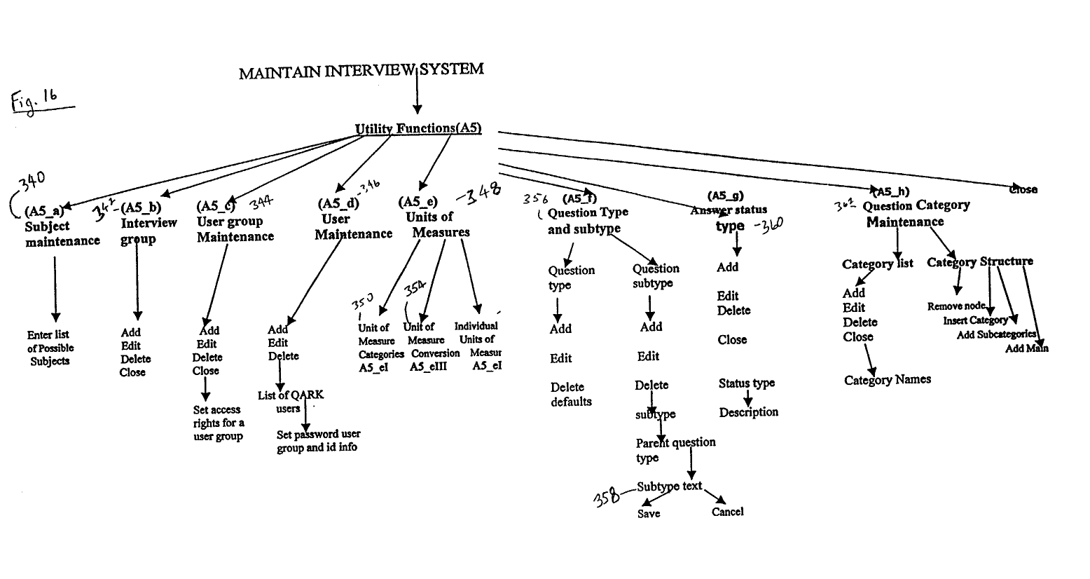

Referring now to FIG. 16, the utility portion of the system will now be described. The utility portion allows the administrative user to add, edit, and define information that is used by the system. The utility portion allows the administrative user to add, edit and define rights for interviewees, interviewers, groups of interviewees, groups of interviewers. The system also allows the high level administrative user to define and manage units of measurement and conversion constants between units of measurement; edit and define question-answer formats (i.e. Question Prototypes) and question category information.

The subject maintenance section 340 allows the administrative user to enter the identification of interviewees who are allowed to use the system. The interview group maintenance section 342, allows the administrative user to add, edit, and/or delete the identification of valid groups of interviewees who are allowed to use the system and who's data is to be analyzed as a group for generating group reports as well as statistics.

The user group maintenance section 344 allows the administrative user to enter, edit and/or delete valid groups of users by defining the user group name and rights to access and control various parts of the questionnaire system. For example, typical user groups include administrative, manager and interviewers and interviewees. Each individual user defined in section 340 of the system must also be assigned to a user group.

This allows rights to be assigned to these authorized groups and then users can be associated with that authorized group.

The user maintenance section 346 allows the administrative user to enter, edit, and/or delete the identification of specific individuals who will have administrative, manager, interviewer and/or interviewee level rights and allows them to be assigned to specific user groups. Thus, the administrative user can define the list of authorized interviewers, set access passwords, and interviewer rights.

The units of measure maintenance subroutine 348 includes the units of measure categories 350 that allows the administrative user to edit or add units of measurement categories such as weight, distance, speed, etc as well as the individual units of measurement 352 such as pounds, ounces, feet, inches, meters, miles per hour, etc. In the unit of measure conversion section 354, the subroutine allows the administrative user to add or edit specific numerical constants used to convert one set of units, such as feet to inches, miles, meters, etc to any other type of units of measurement e.g. from English units to metric units.

These units will be used to allow the interviewee to choose from a list of appropriate units for that question with automatic conversion to any other appropriate units as needed by the scoring or statistical software.

For example, this allows the administrative user to convert input data using any measurement system for which they are familiar. A specific example would be to allow an interviewee to input data in any system of weight, e.g. pounds, grams, kilograms, with conversions occurring automatically to the units needed to allow the scoring of the interviewee's answers by comparison to the variables stored inside the QFU that may have different units.

In general, the “units of measure maintenance” category 348 allows the administrative user to add or edit categories of units such as area, distance, duration, frequency, etc. When a QFU is created, the administrator can allow the interviewee to be restricted to input specific units or to allow the interviewee to input any appropriate type of units. Section 345 contains and maintains the information that is needed to allow for all “units of measurement” conversions.

Section 356 allows the administrative user to define question prototypes (QPT) and subtypes. Section 356 allows the user to add, edit, delete answer formats, i.e. Question Prototypes (QPT). QPT are objects that are combined with a rhetorical question statement to create an answerable question as a QFU. For example a question statement “Have you ever used alcoholic beverages” could be attached to a “yes/no” answer; or, “multiple choice” answer; or “date range”, etc. The QPT that are maintained in section 356 will be used in subsection 43 of section 38 (See FIG. 2C). Section 356 also allows the administrator to set defaults for the variables inside each QPT that will be needed inside each QFU to allow it to function properly, e.g. data in QPT are used to score the interviewee's answer during an interview.

Additionally, the subroutine 356 also allows the user to create subtype questions (section 358) which are a logical extension of the QPT that allows for creation and utilization of specific cases of the parent QPT (question prototype or answer format) with specific text and data. For example, the multiple choice question prototype (i.e. QPT=1) could have multiple specific cases e.g.

subtype=“Choose best answer A” with data={a) first choice b) second choice c) third choice d) fourth choice}.

Subtype=“Choose the false answer” with data={a) This fact, b) that fact, c) another fact d) one more fact}

Subtype=“Choose best answer B” with data={1) a good fact 2) a big fact 3) a small fact 4) a green fact}

Answer subtypes are another tool that allows for maximal flexibility and rapid development by allowing the system to create and utilize a library of error free modular tools that can be put together to rapidly develop new questions to be placed in questionnaires.

The answer status type section 360 allows the administrative user to define categories that are used to categorize the results when questions are automatically analyzed and scored during the interview. That is, when a question is answered in an interview, the QFU that contains the question and means of answering that question can automatically score the interviewee's answer based on predefined criteria that is stored in the QFU. This feature allows the administrative user to define any “answer status types” that are terms used to label the results of the scoring process internal to each QFU. These terms could be normal, abnormal, neutral, bad, good, etc. For example, a QFU regarding smoking cigarettes could have internal criteria regarding cigarette usage, (e.g. the amount of cigarettes smoke per day, the number of years that cigarettes have been used). Based on those criteria, if a certain threshold is exceeded then the answer status type could be set to “abnormal”. If the answer does not exceed the threshold then the answer would be labeled as “normal”. If the question was not answered then the answer would be labeled as “neutral”. This function then allows for the answer status to be saved with the QFU and which may later be used for other forms of analysis such as statistical analysis.

In the question category maintenance section 362, these subroutines allow the administrative user to define lists of categories that are used to index QFU for the purpose of filtering, sorting and organizing QFU by topic for reports, data views and in preparation for statistical analysis. These categories are stored in a category library and each category in the library can be indexed to allow sorting by topics such as fields of interest, e.g. engineering, medicine, law, etc. Furthermore, the categories can be arranged into tree structure relationships and are also indexed and saved into a library of tree structure categories. The tree structure is a two dimensional array that shows the logical relationship between each category in that tree structure as seen in FIGS. 3A and 3B. The categories are used to tag each QFU for purposes of sorting, filtering and organizing for reports, data views and statistical analysis.

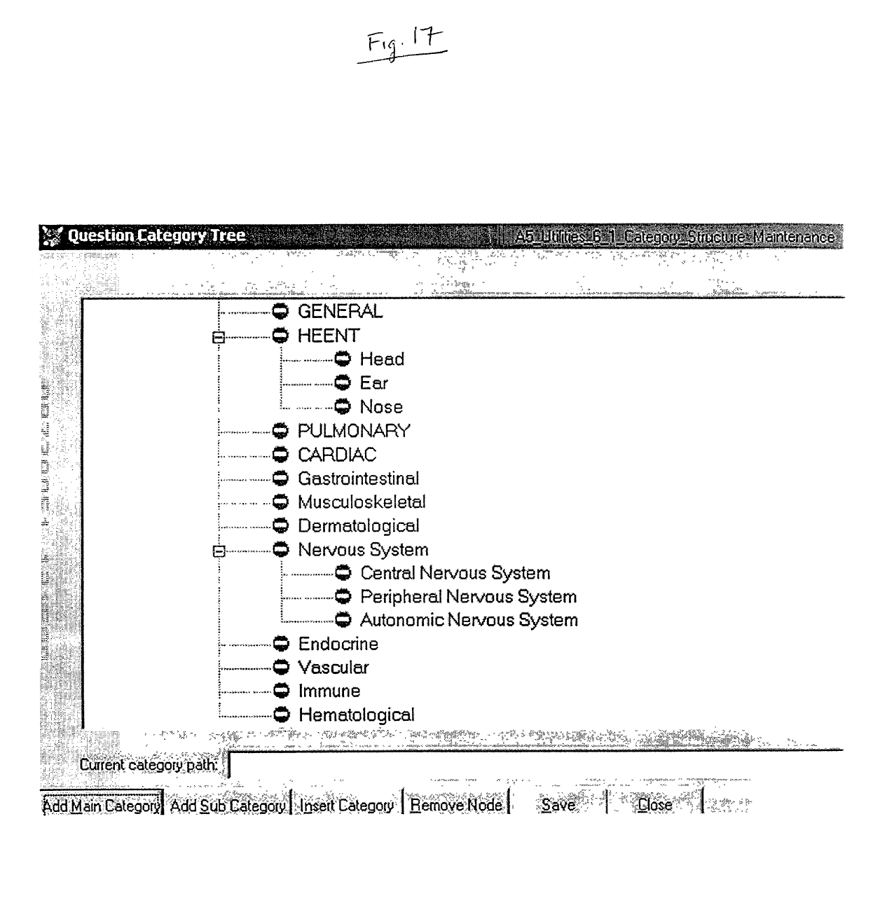

FIG. 17 is illustrative of a category tree structure that is appropriate for medicine. As noted, the tree structure includes the category list that is organized to show the relative relationship between all categories. In this example of medical category tree includes categories such as General, HEENT, Pulmonary, cardiac, Gastrointestinal, etc. The tree structure allows for categories to have a subordinate relationship to other categories, e.g. the category HEENT is associated with the subcategories of head, ear, nose in the tree structure. Thus, QFUs dealing with Pulmonary will be grouped under the Pulmonary category. A subcategory under the category “Nervous system” is shown, which includes central nervous system, peripheral nervous system and autonomic nervous system. According to the teachings of the present invention, the administrative user could create a subcategory under Pulmonary such as “lower lungs” and “upper lungs”.

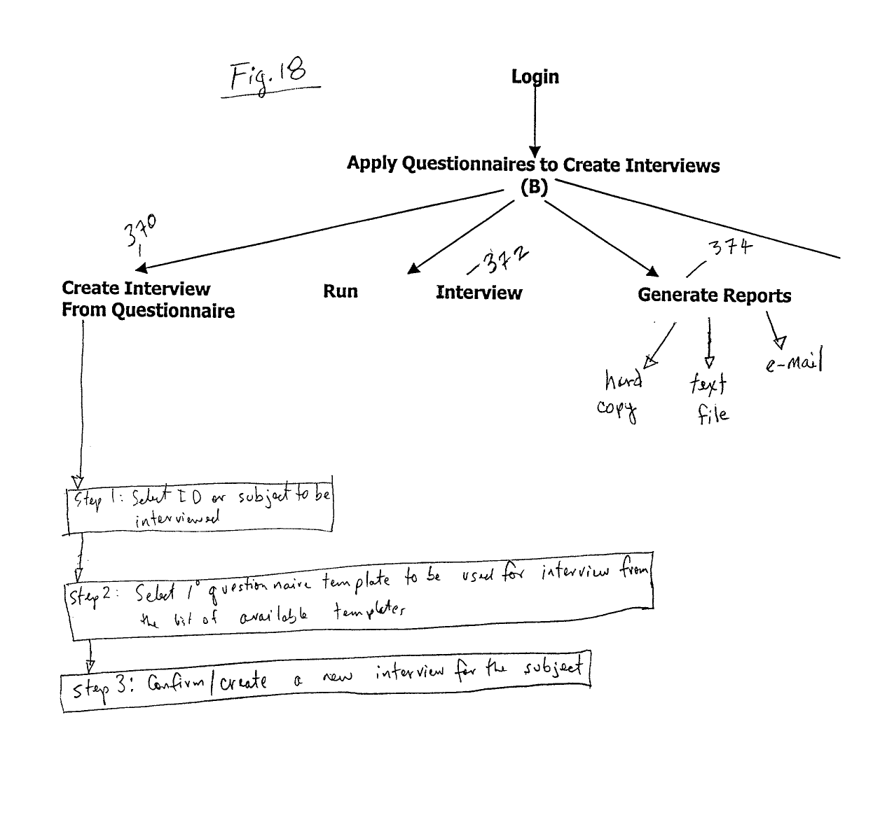

As seen in FIG. 18, the subroutines to create an interview from questionnaire templates will now be discussed. The “create interview from questionnaire template” section 370 allows an administrative user to take a questionnaire template and to create a specific instance for a specific interviewee. An instance is a functional copy of the questionnaire template that has been initialized with data specific for an actual interviewee and can be run as an interviewee. Once an interview has been created it can be distributed via networks or optical or magnetic storage devices. The interview can be supervised by an interviewer and answered by an interviewee, or the interview can be run and answered by an interviewee 372. As the interview is run, it automatically collects and stores the answer data. At anytime, the interviewer can generate a report 374 listing all questions with their answers as well as summarizing the scores that were calculated on each QFU during the interview. All results can be output to hard copy, file or E-mail.

More specifically, in order to create an interview, the first step is to select the person to be interviewed i.e. interviewee. Then, the administrator, manager or interviewer would select the questionnaire template to be used for the interview from the library of available questionnaire templates (FIG. 17). The next step is to confirm and create an instance of the questionnaire template with the interviewee's name, id number, date of birth, etc to create a new interview for that specific interviewee. Once the interview is created it can be run at anytime and the interview can be programmed to be run within a specific time and date range or allowed to be run at any time. If the interview is halted, it can be resumed and will start where it left off. The status icons seen in the tree view allows the interviewee and interviewer to see the status of each question and/or category, i.e. not asked yet, asked and completed, asked but not finalized, refused to answer, do not understand question, etc.

Once a specific interview is selected and started, the interview will be run (372). If this interview contains a reiterative background template marker, then when the interview is run, the system will reiteratively ask the interviewee to a) input multiple sets of background data “N” times and then b) look up the appropriate secondary questionnaire template question set and c) make multiple “N” instances of this secondary questionnaire template that are d) labeled with the data from each of the “N” input cycles and e) insert these “N” instances inside the interview and then f) save this new combined interview and then g) run the new combined interview.

For example, if a job history is being obtained, then the system will ask the interviewee to give all previous employer names and dates. The system will then label the job history section of the sub questionnaire template with the names and dates and then insert it into the live interview in the appropriate place for the correct number of jobs. Thereafter, the interviewee can continue to run the interview queries and collect answer data until the interview is completed.

In order to generate reports 374, the administrative user, manager or interviewer selects an interviewee or selects a group of interviewees; then, they select the categories they want to include in the report as well as the general format for the report. A report format type can be chosen to allow for predetermined formats to be saved and used again in the future. The method allows the choice as to whether to include or exclude various categories as well as memos that were recorded during the interview. The categories include “asked”, “not asked”, “normal”, “abnormal”, “significant”, “not significant”, “suspicious data”, “valid data”, etc.

The memos include “what makes symptoms better”, “what makes symptoms worse”, general comments, etc.

At any point in this process, the program allows going back to previous page, or send interview to printer, print to file or E-mail.

Although the present invention has been described in terms of specific embodiments, it is anticipated that alterations and modifications thereof will no doubt become apparent to those skilled in the art. It is therefore intended that the following claims be interpreted as covering all such alterations and modifications as fall within the true spirit and scope of the invention.

In the claims:

1. A method of creating questionnaires comprising:
creating a plurality of question statements;
creating a plurality of answer formats;
combining a single question statement with a single answer format to create a question function unit (QFU);
combining said plurality of question statements with said plurality of answer formats to create a plurality of QFUs;
categorizing said plurality of QFUs.

2. The method of claim 1 further comprising:
creating a plurality of question macros, said question macros comprising a list of said QFUs;
creating a questionnaire template comprising a two dimensional tree structure from said single QFU wherein said tree structure contains a plurality of nodes and branches;
creating a working interview as an instance of the questionnaire template.

3. The method of claim 3 further comprising:
embedding a background template marker at a first node within said primary questionnaire template tree structure;
reiteratively collecting an input information defined in the background template marker from an interviewee during an interview.

4. The method of claim 3 further comprising:
providing answers to said question statements;
scoring each said answer based on a predetermined criteria in said answer format;
providing a response to the question statements wherein said response generates a link to an e-mail protocol;
sending an e-mail to a preselected address based upon the response provided for said question statement.

5. The method of claim 3 further comprising:
selecting a predetermined answer as a criteria within a first QFU;
providing a link to an universal resource locator for a web page site;
providing the criteria as an answer in an interview to said first QFU;
linking the answer to the web page site.

6. The method of claim 3 further comprising:
editing said plurality of QFUs;
saving said edited plurality of QFUs.

7. The method of claim 3 further comprising:
editing said plurality of QFUs;
creating a questionnaire template comprising said edited plurality of QFUs;
creating a second plurality of QFUs;
creating a second questionnaire template with said edited QFUs and said second QFUs.

8. The method of claim 3 further comprising:
authorizing a group of interviewees to apply to said questionnaire template;
applying said questionnaire template by said group of interviewees.

9. The method of claim 3 further comprising:
performing a scoring process on each answer based on a standard that is stored internal to each said QFU.

10. The method of claim 3 wherein the step of creating an answer format includes:
creating a multiple choice answer format;
creating a date range answer format;
creating a comment answer format.

11. The method of claim 3 further comprising:
placing said QFUs, said question macros, and said questionnaire templates on a server;
linking said server to a global network of computers;
logging on to the global networks of computers by an administrative user;
accessing said QFUs, said question macros, and said questionnaire templates on the server for network access.

12. A process for interviewing comprising:
creating a first plurality of question function units (QFUs);
creating a second plurality of QFUs;
creating a question template comprising said first and second QFUs, wherein said question template is arranged in a two-dimensional tree structure;
providing a macro question comprising a list of said first and said second QFUs;
placing said macro question, said question template, and said first and said second QFUs on a server;
accessing said server;
accessing said question template in order to initiate an interview.

13. The process of claim 12 further comprising:
providing answers to said QFUs contained within said question template.

14. The process of claim 13 wherein said server is linked to a global computer information network, and wherein the step of accessing said server includes accessing the server from a remote computer linked to said server via the network.

15. The process of claim 13 wherein said server is linked to a global computer information network, and wherein the step of accessing said server includes modifying said first and said second QFUs.

16. The process of claim 15 further comprising:
sending an e-mail based upon a predetermined answer to a question statement contained within said QFU.

17. The process of claim 16 further comprising:
linking the question template to an universal resource locator on the world wide web based upon the predetermined answer to the question statement contained within said QFU.

18. The process of claim 17 further comprising:
saving said question template to a file on the server.

19. The process of claim 18 further comprising:
accessing said file at a subsequent date.

20. The process of claim 19 further comprising:
retrieving said file;
editing said file.

21. The process of claim 20 further comprising:
performing a statistical analysis based on said answers received in the interview.

22. The process of claim 21 further comprising:
embedding a background template marker means within said tree structure of said question template.

23. A data management question and answer system comprising:
a master library of predefined questions comprising a question function unit (QFU);
wherein said QFU comprises: a question statement; means for editing said question statement; and, means for creating answer formats that are linked to said question statement.

24. The system of claim 23 further comprising:
means for duplicating said QFU and said question statement in order to create a plurality of question functional units (QFUs) and wherein said duplicating mean includes means for dropping and dragging said QFUs, question statements, said editing means, and said answer formats.

25. The system of claim 24 wherein said QFUs are arranged in a plurality of categories, and wherein said categories are arranged as a question template in a tree structure.

26. A process for interviewing comprising:
creating a first plurality of question functional statements (QFUs), said first QFUs comprising a question statement and means for answering said question statement;
categorizing said QFUs;
placing said first QFUs into a question template comprising a tree structure based on said first plurality of categories;
placing said question template on a server;
restricting access to said question template to a plurality of authorized users;
accessing said server by said plurality of authorized users from a remote computer;
accessing said question template from the remote computer;
providing an interview by creating an instance of said question template to an interviewee.

27. The process of claim 26 further comprising:
creating a second plurality of QFUs;
categorizing said second QFUs.

28. The process of claim 27 wherein said means for answering comprises:
a means for providing a default answer;
a means for providing an answer status and score;
a means for providing an answer based on a predetermined list of choices;
a means for converting units of measure of the answer from a first unit of measure to a standard unit of measure; and wherein the process further comprises:
converting the unit of measure inputted by the interviewee to the unit of measure needed to compare and score said answer to said standard unit of measure.

29. The process of claim 28 further comprising:
selecting a sub questionnaire template;
embedding a background template marker into a node in the tree structure on the first question template;
linking said sub questionnaire template with said background template marker; and
wherein the process further comprises:
generating said sub questionnaire template once said background template marker is encountered by the interviewee;
generating answers to said question template.

30. The process of claim 29 further comprising:
generating a statistical analysis of said answers.

31. The process of claim 29 wherein said server is linked to a global computer information network, and wherein the step of accessing said server includes accessing the server from a remote computer linked to said server via the network.

32. The process of claim 29 wherein said server is linked to a global computer information network, and wherein the step of accessing said server includes:
creating a third QFU.

33. The process of claim 29 further comprising:
sending an e-mail based upon a predetermined answer to a specific question statement.

34. The process of claim 29 further comprising:
linking the interviewee to an universal resource locator on the world wide web based upon a predetermined answer to a specific question statement.

35. The process of claim 29 further comprising:
saving said question template, said first and second QFU, and said macro question.

36. The process of claim 35 further comprising:
accessing said file at a later date.

37. The process of claim 36 further comprising:
retrieving said file;
editing said file.

38. The process of claim 37 further comprising:
performing a statistical analysis on said answers in said interview.

39. The process of claim 38 wherein said means for answering includes an option to answer the question statement as a multiple choice and wherein the process further comprises:
choosing and an answer among said multiple choices.

40. A data management question and answer system comprising:
a plurality of question functional statements (QFUs) arranged in a categorical array, said QFUs comprising: a plurality of question statements; and, means, operatively connected to said question statements, for answering said question statements including: means for editing said question statements; and, means for creating dynamic and customized answer formats.

41. The system of claim 40 further comprising:
a sub questionnaire template, said sub questionnaire template comprising: a second QFU;
a background template marker embedded into a node in the QFUs categorical array;
a means for linking said sub questionnaire template with said background template marker;
means for generating said sub questionnaire template once said background template marker is encountered.

42. The process of claim 41 further comprising:
means for generating a statistical analysis based upon the responses given to said question statements.

43. The system of claim 41 further comprising:
means for dropping and dragging the QFUs within the tree structure;
means for monitoring the status of said question statements.

44. A questionnaire system comprising:
a plurality of question functional units (QFUs), wherein each of said QFUs comprise a question statement and a means for answering said question statement;
wherein said QFUs are arranged in a two dimensional question template having a hierarchical tree structure having nodes.

45. The system of claim 44 further comprising:
a background template marker placed at a first node in said question template, wherein said marker is operatively linked to a sub questionnaire.

46. The system of claim 45 further comprising:
a plurality of macro questions, wherein said macro questions comprises a group of said QFUs.

47. The system of claim 46 wherein said answering means includes:
a plurality of question prototypes (QPTs), wherein said QPTs include an answer format for answering said question statement.

48. The system of claim 47 wherein said QFUs are categorized and wherein the system further comprises:
a category index comprising said categorized QFUs.

49. The system of claim 48 wherein an individual QPT comprises a multiple choice answer format.

50. The system of claim 49 wherein the individual QPT comprises a default answer.

51. The system of claim 50 wherein the individual QPT comprises a logic gate means for controlling the downstream QFUs.

52. The system of claim 51 wherein the individual QPT comprises an answer status data flag means for determine the answer status for the QFUs.

53. The system of claim 52 further comprising means for generating reports to an applied question template.

54. A method of applying an interview comprising:
developing a plurality of question functional units (QFUs);
creating a two dimensional question template, wherein said two dimensional question template comprising said QFUs;
creating a template background marker;
inserting said background template marker in a node of said question template;
generating an interview;
applying said interview.

55. The method of claim 54 wherein the step of developing said QFUs comprises:
providing a question statement and means for answering said question statement, and wherein said answering means includes a question prototype (QPT) having an answer format.

56. The method of claim 55 wherein said QPT further includes a data flag and the method includes activating said data flag.

57. The method of claim 55 wherein said QPT further includes a default answer and the method includes activating said default answer.

58. The method of claim 55 wherein said QPT further includes a logic gate and the method further includes activating said logic gate controlling the downstream QFUs.

59. The method of claim 55 wherein said step of inserting said background template marker further comprises deploying a subroutine that looks up a category label; inserting the data into said category label; cycling through the collection of the data as determined by the input; locating a sub questionnaire template; copying the sub questionnaire template N times; inserting the sub questionnaire template into the interview N times.

60. The method of claim 55 further comprising creating a second background template comprising:
providing a name;
labeling a parent category;
labeling a secondary category;
labeling a tertiary category;
placing said second background template in a second node in said question template.

61. The method of claim 55 wherein the step of creating the interview includes:
selecting an interviewee;
selecting the question template to be used for the interview;
creating an instance of the question template for the interviewee to undertake.
